(19) United States
(12) Patent Application Publication
(10) Pub. No.: US 2025/0107561 A1
(43) Pub. Date: Apr. 3, 2025

(54) CUTTING AND SHAPING DEVICE

(71) Applicant: EMMI SCHWEIZ AG, Luzern (CH)

(72) Inventors: Kurt LOOSLI, Pieterlen (CH); Stefan PURTSCHERT, Hindelbank (CH); Marc WINKELMANN, Wil SG (CH); Thomas BOHL, Romanshorn (CH)

(21) Appl. No.: 18/833,208

(22) PCT Filed: Aug. 31, 2022
(86) PCT No.: PCT/EP2022/074164

§ 371 Date: Jul. 25, 2024

(30) Foreign Application Priority Data
Jan. 28, 2022 (CH) CH000082/2022

(51) Int. Cl. A23P 30/00; A01J 27/00; B26D 3/28; B26D 7/18

(52) U.S. Cl. CPC A23P 30/00; A01J 27/00; B26D 3/281; B26D 7/1818; B26D 2210/02

(57) ABSTRACT

A cutting and shaping device for producing shaped cut items of a block of food. The cutting and shaping device comprises at least a receptacle for positioning the block of food, a blade for cutting the items off the block of food, a shaping gripper for gripping and shaping the cut items, and a control unit.

### PRIORITY CLAIM

This international patent application claims priority from Swiss patent application CH 000082/2022, filed on Jan. 28, 2022, the contents of which are hereby incorporated by this reference,

### TECHNICAL FIELD OF THE INVENTION

The present invention relates to a cutting and shaping device for producing shaped cut items.

### DESCRIPTION OF THE TECHNICAL FIELD

In the field of food processing, it is a specialty to produce food products in special shapes for sale. Cheese, for example, is known to be offered not only in pieces or slices, but alternatively also as curd cheese, sliced rolls or rosettes. These shaped pieces usually require the cheese to be processed by hand, which makes production time-consuming, For example, staff must work in a refrigerated environment and a higher number of shaped cheese products requires a correspondingly high number of staff. Staff must also be appropriately trained to achieve uniform shaping of the food. Particularly in the production of more complex shaped products such as Tête de Moine rosettes, the processing of the rosettes, for example for shaping and filling, has so far required human intervention, for example to achieve visually appealing yet standardized rosette shapes and their arrangement in the sales box.

### SUMMARY OF THE INVENTION

It is the object of the present invention to provide a device for the automated cutting and shaping of cut items from a food block.

The object is solved by providing a cutting and shaping device having the features of claim 1. Further embodiments are defined in further claims.

The cutting and shaping device comprises:

A receptacle with a support surface. The receptacle is designed in such a way that a block of food can be placed on the support surface and, optionally, positioned in relation to other elements of the cutting and shaping device.

The receptacle and/or the support surface can be adapted to the shape of the food block to be treated. Alternatively, it is conceivable that, for example, if the shape of the receptacle and/or the support surface is specified by other parameters, the food block can be adapted to the shape of the receptacle and/or support surface.

For example, the support surface can be plate-shaped. Other, modified or alternative shapes of the support surface are also possible, for example shapes that are not a flat surface but a three-dimensional surface, such as a wedge shape.

In the context of the present invention, the side of the food block that rests on the support surface of the receptacle is also defined as the underside of the food block.

The cutting and shaping device also comprises a knife with a cutting edge. The cutting edge can be used to cut off items from a food block positioned on the support surface of the receptacle. For this purpose, the knife is positioned opposite the support surface and can also be positioned if possible.

It is provided that the knife or the receptacle is designed to rotate about a first axis of rotation or that the knife and the receptacle are designed to rotate about a first axis of rotation. It is important that the knife and the support surface are moved relative to each other and against each other by means of the rotation, This relative movement of the knife and the support surface in relation to each other and their position in relation to each other allows one or more pieces to be cut off a block of food that has been placed on top.

In the context of the present invention, the terms rotation, turning, rotational movement and turning movement are used interchangeably, unless they are explicitly used for different contexts. They describe a movement about an axis. This axis is also referred to as the axis of rotation.

It is also provided that the knife and the receptacle are designed to be movable relative to each other along the first axis of rotation. For this purpose, the knife can be movable or the receptacle can be designed to be movable accordingly.

Alternatively, both the knife and the receptacle can be movable accordingly.

It is provided that during this movement both a movement towards each other and a backward movement, i.e. a movement away from each other, is possible.

The cutting and shaping device also includes a shaping gripper. The shaping gripper can be aligned with a distal end towards the cutting edge of the knife. It is also designed to automatically grip and shape cut items. For this purpose, the shaping gripper can preferably be positioned relative to the cutting edge of the knife. The shaping gripper can preferably be positioned relative to the cutting edge of the knife by moving the shaping gripper. Alternatively, the receptacle and the knife can be moved in relation to the shaping gripper, or both the shaping gripper and the receptacle and knife can be moved in relation to each other.

The distal end of the shaping gripper is the end with which the shaping gripper is positioned closest to the knife when the knife is in a cutting position and the shaping gripper is in the correspondingly aligned gripping position. Preferably, the distal end positioned opposite the shaping gripper extends along a straight line which is aligned with the cutting edge of the knife. Particularly preferably, the distal end of the shaping gripper is aligned parallel to the cutting edge of the knife.

It may be provided that at a proximal end of the shaping gripper it comprises holding elements with which the shaping gripper is held within the cutting and shaping device. The proximal end is referred to here as the end opposite the distal end. It may be provided that the shaping gripper is interchangeably attached to a gripper receptacle, for example with one or more holding elements at its proximal end.

Finally, the cutting and shaping device comprises a control unit designed to control the shaping gripper. The control unit is also designed to control the positions of the shaping gripper, the receptacle and the cutting edge of the knife in relation to each other.

In the context of the present invention, slicing is understood to include cutting, slicing and scraping. When cutting, the knife generally extends parallel to the cutting surface on the food block. When slicing, the knife is arranged at a short angle to the cutting surface on the food block. When scraping, the knife is arranged perpendicular to the cutting surface on the food block. In the case of the present invention, it is irrelevant whether the knife is moved relative to a stationary food block, whether the food block is moved relative to a stationary knife, or whether both the knife and the food block are moved relative to each other. For the sake of simplicity, the term cutting is understood to mean any severing of parts of the food block by means of the knife, unless explicit reference is made to a specific operation, The cutting and shaping device according to the invention can be designed for cutting, slicing or scraping depending on the arrangement of the knife, wherein cutting is used more as an umbrella term.

As described in more detail below, in a preferred embodiment, the cutting and shaping device is designed for scraping scraped items, wherein the knife is arranged vertically opposite a cutting surface and the food block is rotated relative to the knife by means of the receptacle.

In the context of the present invention, a food block is understood to be a solid or semi-solid food body which can be positioned and rotated on a receptacle in a substantially dimensionally stable manner. The strength of the food block is described below using the example of a cheese block. For example, Swiss cheese types are classified according to Article 52 paragraph 2 VLtH (Ordinance of the FDHA of Dec. 16, 2016 on Food of Animal Origin; SR 817.022.108) according to the water content in the fat-free cheese (wff) into the following firmness levels;
a. extra-hard up to 500 g/kg;
b. hard more than 500 to 540 g/kg;
c. semi-hard more than 540 to 650 g/kg;
d. soft more than 650 g/kg.

A cutting and shaping device according to the present invention can be designed in particular to process a hard and semi-hard cheese block as defined above. Also suitable for use in a cutting and shaping device according to the invention are food blocks which have a comparable hardness. Suitability can be achieved or improved, for example, by adjusting the hardness and thickness of the knife, the speed of rotation of the food block relative to the knife and the penetration depth of the knife into the food block. The processing temperature, for example, can also be used to influence the firmness of a food product and thus its suitability. Similarly, processability can be achieved by means of the knife temperature or other aids such as ultrasound (to prevent cut food from sticking to the knife) or coatings on the food block (e.g. wax). In addition to various cheese blocks, other suitable foods in block form include sausage or meat products, fats such as butter, chocolate or ice cream.

The support surface has a shape and size that is suitable for stably supporting the desired food block. Its shape can be adapted to the shape of the food block. A preferred shape is, for example, a circular shape (i.e. plate-shaped) or a circular ring. A square, in particular a square or a regular polygon, is also suitable. If the receptacle is designed to rotate about the first axis of rotation, the shape of the support surface and preferably also the shape of the receptacle itself is preferably selected so that a smooth rotational movement is possible.

In addition to its base area, the support surface can also have a height extension. For example, the support surface can be conical or frustoconical. In this case, it has a circular base surface and also a lateral surface that extends upwards. In this case, a food block can act on the lateral surface in particular. The support surface can provide additional support for the food block. Other surfaces are also conceivable as long as a food block can be placed on the receptacle and can also be positioned.

The first axis of rotation preferably extends perpendicular to the support surface or, if the support surface has an extension in height, perpendicular to its base surface.

The control unit of the cutting and shaping device is a processing unit that controls one or more processes according to previously stored commands. Such commands can be stored in the form of a software program, for example. The control unit controls the various functions or actions of the cutting and shaping device by linking the individual components with each other in terms of function and control technology and coordinating them with each other.

In particular, the control unit is designed to control the shaping gripper for shaping the cut items. The control unit is also designed:
to control the rotation of the receptacle about the first axis of rotation if the receptacle is designed to be rotatable. In this case, the control unit is preferably designed to control a drive of the receptacle, with which the receptacle is automatically rotated about the axis of rotation; and/or
to control a movement of the receptacle along the first axis of rotation if the receptacle is designed to move along the axis of rotation. Preferably in this case, the control unit is designed to control a drive of the receptacle, with which the receptacle is moved along the first axis of rotation, Preferably, this movement is linear; and/or
to control a rotation of the knife about the first axis of rotation if the knife is designed to rotate about the axis of rotation. In this case, the control unit is preferably designed to control a drive of the knife with which the knife is moved about the first axis of rotation; and/or
a movement of the knife along the first axis of rotation when the knife is movable along the first axis of rotation. Preferably in this case, the control unit is designed to control a drive of the knife, with which the knife is moved along the first axis of rotation. Preferably, this movement is linear.

It may be provided that the cutting and shaping device comprises a central control unit which is functionally connected to the various elements of the cutting and shaping device. Alternatively, it may be provided that individual or each element of the cutting and shaping device comprises its own control unit. In this case, the individual control units are preferably functionally connected to each other.

A control unit can be an internal or external processor. An internal processor can, for example, be a processor integrated into the respective element of the cutting and shaping device. An external processor can be, for example, a processor of a personal computer (PC) or generally a computer system that is functionally connected to the corresponding element of the cutting and shaping device,

The control unit can control the various elements of the cutting and shaping device using one or more sensors, as will be explained later,

In one embodiment of the invention, which can be combined with any other embodiment previously mentioned or yet to be mentioned, provided they do not contradict each other, the shaping gripper comprises at least two gripper jaws which can be moved against each other. Each gripper jaw has an inner side. Together with their inner sides, the gripper jaws form a shaping receptacle for cut items cut from a block of food.

In this case, moving relative to each other means moving towards each other and away from each other. It may be provided that both gripper jaws move towards or away from each other. Alternatively, it may be provided that only one gripper jaw is movable relative to the other gripper jaw, while the other gripper jaw is motionless.

By moving the gripper jaws relative to each other, the shaping gripper is brought into a closed state, in which the gripper jaws are positioned as close as possible to each other, and into an open state, in which the gripper jaws are further apart from each other. In the closed state, the shaping receptacle is reduced in size, while it is enlarged in the open state.

Preferably, the shaping gripper can hold cut items in its receptacle in the closed state, even if it is moved away from the knife, for example, in order to transport the cut items to a filling station. In the open state, on the other hand, the shaping gripper can pick up cut food slices and also release them again. In addition, the gripper jaws are dimensioned and shaped in such a way that, in the closed state, they bring the cut items into a desired shape in the receptacle.

Preferably, those sides of the gripper jaws that are closer to the cutting edge of the knife form the distal end of the shaping gripper,

It may be provided that the gripper jaws are attached to a gripper holder. An interchangeable attachment is particularly suitable. For example, the same cutting and shaping device can be used to automatically shape cut items into different forms by using differently shaped shaping grippers or gripper jaws in the cutting and shaping device. It may also be possible to replace the entire shaping gripper or only individual gripper jaws or each gripper jaw within the shaping gripper.

Alternatively, it may be provided that the gripper jaws are immovable in relation to each other. In this case, shaping takes place simply by picking up the cut items in the shaping receptacle. Whether the gripper jaws are designed to be movable against each other or immovable can be determined, for example, by the properties of the cut items and the desired shape.

In one embodiment of the invention, which can be combined with any other embodiment previously mentioned or yet to be mentioned, provided they do not contradict each other, the shaping gripper is designed as an angular gripper or as a parallel gripper.

The shaping gripper is preferably designed as a parallel gripper.

In one embodiment of the invention, which may be combined with any other embodiment previously mentioned or yet to be mentioned, provided they do not contradict each other, the gripper jaws are formed and arranged relative to each other so as to form a cone-shaped receptacle at the distal end of the shaping gripper.

This shape is particularly suitable for shaping scraped items from a block of cheese into a rosette shape.

A cone-shaped receptacle is particularly suitable for forming rosettes, for example cheese rosettes. The shape can already be influenced in a first step by choosing the arrangement of the knife (e.g. as a scraper) when cutting. The shaping gripper can then bring the preformed cut items into a standardized shape and size, for example into a standardized rosette shape. In this way, cut items with a standardized shape (in this case rosettes) can be inserted into the corresponding packaging. Conical also includes a truncated cone shape. Alternative shapes of the receptacle, for example a circular cylinder, an elliptical cylinder or prism-shaped cylinders can also be provided. The shape can be based on a straight or inclined basic shape.

The arrangement of the conical receptacle at the distal end makes it easier to shape the cut items. This means that the items cut off with the knife can fall into the open shaping gripper immediately after the cutting process and can also be formed into the desired shape there by closing the shaping gripper. Preferably, the height of the receptacle cone extends along the straight line of the distal end. Both the more pointed end and the wider end of the receiving cone are therefore located at the distal end of the shaping gripper.

In one embodiment of the invention, which can be combined with any other embodiment previously mentioned or yet to be mentioned, provided they do not contradict each other, the shaping gripper comprises an ejector with a support surface for cut items. The ejector is designed to move back and forth in the receptacle and in the direction of the distal end of the shaping gripper. The ejector can optionally also be designed to move out of the shaping gripper at its distal end.

In this embodiment, the ejector thus delimits the receptacle between the gripper jaws with its support surface, specifically on the side opposite the distal end. The ejector can be used to eject a section of food from the shaping gripper that is in the receptacle of the shaping gripper. Ejection takes place by bringing both the shaping gripper into the open state and moving the ejector in the direction of the distal end. The food product lying on the support surface of the ejector is thus lifted out of the receptacle,

It may be provided that when the ejector moves in the direction of the distal end, the support surface can be moved, for example, until it is flush with the distal end of the shaping gripper or even further beyond the distal end, so that the cut items are ejected even better from the shaping gripper.

It may be provided that the support surface of the ejector is adapted to the shape of the receptacle between the gripper jaws and thus also influences the shaping of the cut items in the shaping gripper. If, for example, the receptacle of the shaping gripper is cone-shaped, the support surface can complete the cone shape in the proximal direction—for example, the lateral surface can extend parallel to the straight line of the distal end, while the imaginary base surface of the cone extends between the distal and proximal ends. The support surface can therefore close off the receptacle essentially precisely on the side opposite the distal end.

In one embodiment of the invention, which may be combined with any other embodiment previously mentioned or yet to be mentioned, provided they do not contradict each other, at least one, preferably both, gripper jaws at the distal end of the shaping gripper are finger-shaped with a recess between each finger. Optionally, the ejector can comprise finger-shaped extensions which engage in the recesses between the fingers of the gripper jaws,

The finger shape at the distal end of the gripper jaws not only saves material, it also reduces the surface to which the cut items can adhere. This can improve the handling of the cut items with the shaping gripper, especially when the cut items are discharged from the shaping gripper. If the ejector is also equipped with fingers that engage in the recesses of the gripper jaw fingers, the handling of the cut items can be further improved. For example, the cut items can be moved more easily in the receptacle without them becoming trapped at the boundary between the inside of the gripper jaw and the support surface of the ejector, and the risk of the ejector itself jamming when moving between the gripper jaws is reduced,

It may also be provided that the shaping gripper has a limiting element on one or both sides between the distal and proximal ends of the gripper jaws, which limits the receptacle of the shaping gripper. If, for example, the receptacle is conical in shape, a limiting element can be attached at least to the larger end of the cone (the imaginary base surface). This can prevent the inserted product from falling out sideways when the shaping gripper moves, even if the shaping gripper is in a closed state. A further limiting element can be attached to the narrower end of the conical receptacle. This can be the case in particular if the receptacle is more of a truncated cone shape. Regardless of the shape of the receptacle, one or two limiting elements are provided laterally of the receptacle. It may be provided that it is immovably attached to the shaping gripper,

In one embodiment of the invention, which can be combined with any other embodiment mentioned above or yet to be mentioned, provided they do not contradict each other, the receptacle is designed to rotate about the first axis of rotation at a rotational speed. In this case, the cutting and shaping device comprises a receptacle drive for rotating the receptacle about the first axis of rotation. This receptacle drive is controlled by the control unit.

In this embodiment, it may in particular be provided that the first axis of rotation is perpendicular to the support surface of the receptacle,

The receptacle drive can be used to rotate the receptacle around the first axis of rotation in a controlled and automated manner. A suitable receptacle drive can be, for example, a servomotor-controlled drive, a three-phase motor (e.g. 230V or 400V) or a pneumatic rotary module. The rotary drive is controlled by the control unit. In particular, the control unit is functionally connected to the receptacle drive in such a way that the control unit can control the rotational speed of the receptacle. This includes not only the rotation itself, but also the start and end of the rotation, It is also under the control of the control unit whether the recording does not rotate, in which case the rotational speed=0.

A speed that is particularly suitable for the production of Tête de Moine rosettes can be 400 to 500 revolutions per minute (rpm), for example.

The receptacle is rotatably mounted to allow rotation about the first axis of rotation.

If the receptacle is designed to rotate about the first axis of rotation, it is possible that the knife is designed to be non-rotatable with respect to the first axis of rotation. Alternatively, it is possible, although less desirable from a system engineering point of view, that not only the receptacle but also the knife is designed to rotate about the first axis of rotation, In this case, the rotation of the receptacle and the rotation of the knife must run against each other in order to separate the cut items from a block of cheese placed on the receptacle. In this case, the positioning of the shaping gripper to pick up the cut items must be coordinated with the movement of the knife and receptacle in terms of time and location.

Alternatively, it may be provided that only the knife is designed to rotate around the first axis of rotation, while the receptacle is fixed in rotation. In this embodiment, the relative movement between the knife and the receptacle can also be used to cut off cut items from a food block positioned on the receptacle.

In one embodiment of the invention, which can be combined with any other embodiment mentioned above or yet to be mentioned, provided they do not contradict each other, the knife and the shaping gripper are designed to move parallel to the first axis of rotation. In this case, the control unit is designed to control the movement of the knife and the shaping gripper parallel to the first axis of rotation.

In particular, the control unit controls a movement of the knife in the direction of the receptacle or away from it, in particular along the first axis of rotation. The control unit also controls a corresponding movement of the shaping gripper in the direction of the receptacle and away from it. Finally, the control unit coordinates the movement of the knife and the shaping gripper in relation to one another, namely with regard to the timing and their positions relative to one another.

The thickness of the product to be cut can be influenced by coordinating the rotation of the receptacle and the movement of the knife. For example, for the production of rosettes of a semi-hard cheese such as a Tête de Moine cheese, the rotational speed of the receptacle and a feed of the knife in the direction of the receptacle per complete rotation of the receptacle can be used to achieve a defined penetration depth in an attached cheese wheel. An example of this is a feed movement of the knife in the direction of the receptacle of 0.1 mm to 10 mm per complete revolution of the receptacle, with which rosettes weighing between 6 and 60 g are scraped from a semi-hard cheese such as a Tête de Moine cheese with a diameter of 5 cm to 30 cm at a speed of 300 to 800 revolutions per minute with the receptacle.

Even if the position of the knife can be changed along the first axis of rotation (i.e. by a movement which is guided parallel to the first axis of rotation), it may be provided that the distance of the knife relative to the first axis of rotation (as viewed perpendicularly to the first axis of rotation) is constant. In particular, it is provided that the knife is arranged at a fixed distance from the first axis of rotation, so that it does not pass through the first axis of rotation with its cutting edge.

It may be provided that the cutting edge of the knife is constantly positioned in relation to its distance from the first axis of rotation.

In one embodiment of the invention, which can be combined with any other embodiment previously mentioned or yet to be mentioned, provided they do not contradict each other, the cutting and shaping device comprises a knife drive with which the knife is moved parallel to the first axis of rotation. The cutting and shaping device also comprises a shaping gripper drive with which the shaping gripper is moved parallel to the first axis of rotation.

The control unit is designed to control the movements of the knife along the first axis of rotation and of the shaping gripper along the first axis of rotation by controlling the knife drive and controlling the shaping gripper drive and to coordinate them with one another.

The knife drive can be a servomotor, for example, which has an incremental position measuring system. The control unit is connected to the servomotor by means of signals and can therefore determine the position of the knife in relation to the receptacle, for example, and control it accordingly. It can be a servomotor-controlled linear drive, for example, or alternatively a pneumatic or electromagnetic linear drive,

The drive for moving the shaping gripper along the first axis of rotation can, for example, be a direct electric drive, a pneumatic drive or a hydraulic drive, optionally with a rotation module.

In one embodiment of the invention, which can be combined with any other embodiment previously mentioned or yet to be mentioned, provided they do not contradict each other, the shaping gripper is attached to a rotating device. The rotating device is part of the cutting and shaping device. By means of the rotating device, the shaping gripper can be moved relative to the first axis of rotation. For this purpose, the rotating device is operatively connected to a rotating device drive.

It may be provided that the shaping gripper can be moved together with the rotating device parallel to the first axis of rotation. In this case, it is therefore suspended in an axially guided manner in the cutting and shaping device.

The rotating device can be used to move the shaping gripper away from the first axis of rotation. The rotating device can, for example, be designed as a rotating wheel, which has one or more places for attaching the shaping gripper. It may be provided here that the shaping gripper itself is fixed to the rotating device so that it cannot move relative to the latter. The rotating device itself is designed to be movable about its own second axis of rotation.

The movement of the shaping gripper around a second axis of rotation can, for example, be a rotary movement or a tilting movement.

A suitable receptacle drive can be, for example, a servomotor-controlled drive, a three-phase motor (e.g. 230V or 400V) or a pneumatic rotary module. The rotating device drive is controlled by the control unit.

In one embodiment of the invention, which can be combined with any other embodiment mentioned above or yet to be mentioned, provided they do not contradict each other, the rotating device is designed as a cross-shaped rotary wheel with connection points for four shaping grippers. One shaping gripper is arranged at each end of a cross arm,

In this or other embodiments, a shaping gripper in the cutting and shaping device can be interchangeable. An interchangeable shaping gripper has the advantage that a shaping gripper with a correspondingly shaped receptacle is used for a desired cut items shape. For example, only the gripper jaws that form the receptacle can be replaced, or other elements of the shaping gripper can also be replaced. The interchangeability can be achieved by reversible fastening systems, for example. Examples include screw or pin connections or force-fit connections.

In one embodiment of the invention, which can be combined with any other embodiment previously mentioned or yet to be mentioned, provided they do not contradict each other, the cutting edge of the knife extends perpendicular to the first axis of rotation. In addition, the cutting edge is arranged next to the first axis of rotation.

In this embodiment, the cutting edge of the knife and the first axis of rotation form a 90° angle.

In this embodiment, the axis of rotation does not extend through the cutting edge of the knife. However, it may be possible for one end of the cutting edge to lie on the first axis of rotation.

Alternatively, it may be provided that the cutting edge of the knife extends at an angle to the first axis of rotation which is less than or greater than 90°, Preferably, in this alternative embodiment, the cutting edge of the knife is arranged at an angle of less than 90° to the first axis of rotation. Also in these alternative variants, the axis of rotation does not run through the cutting edge of the knife. However, it may be possible for one end of the cutting edge to lie on the axis of rotation.

In one embodiment of the invention, which may be combined with any other embodiment previously mentioned or yet to be mentioned, provided they do not contradict each other, the support surface of the receptacle is plate-shaped and extends perpendicular to the first axis of rotation,

In one embodiment of the invention, which may be combined with any other embodiment previously mentioned or yet to be mentioned, provided they do not contradict each other, the receptacle comprises one or more holding elements which are arranged at least on the support surface for holding a food block to be placed on the receptacle.

In one embodiment of the invention, which may be combined with any other embodiment previously mentioned or yet to be mentioned, provided they do not contradict each other, such a holding element is selected from a group comprising:
a web that extends from the receptacle in the direction of the slicing knife. The web can also extend around the first axis of rotation or radially away from the first axis of rotation in the direction of the outer edge of the support surface;
a mandrel or clamping nail that extends from the receptacle in the direction of the slicing knife;
a pair of claws or grippers, which are arranged to the side of the support surface and clamp the food block to hold it in place;
a clamping ring. The clamping ring can rotate together with the receptacle if the latter is designed to rotate; and
a vacuum device which is designed to suck in a food block placed on the receptacle.

In one embodiment of the invention, which may be combined with any other embodiment previously mentioned or yet to be mentioned, provided they do not contradict each other, the cutting and shaping device comprises a separating device. The separating device is designed to guide cut-off items into the shaping gripper. For this purpose, the separating device is designed to move back and forth relative to the first axis of rotation. The movement of the separating device depending on the position of the knife is controlled by the control unit.

In particular, it is provided that the separating device can be positioned relative to the knife, especially relative to its cutting edge. Positioning takes place via a back and forth movement. The cutting and shaping device also comprises a cutting device drive with which the movement of the cutting device is carried out under the control of the control unit. By means of a cutting device drive controlled in this way, cut items that have been cut off from an attached food block can be automatically guided into the receptacle of the shaping gripper. The movement of the separating device can, for example, be a linear movement, a rotational movement or a tilting movement.

The separating device supports the separation of the cut items from the food block. Cut items are actually cut from the food block using the knife, and separation takes place when the knife is released from the food block. The knife can be released, for example, by a backward movement of the knife, i.e. a movement away from the food block. If the knife is pulled back, the separating device can be pushed forward at the same time, so that the separating device thereby pushes the cut items from the food block and, optionally, from the knife,

A separating device is particularly suitable if the cut items easily stick to the knife and there is a risk that they will be torn apart when the knife is pulled back. This is the case for various types of cheese, for example. The separating device can be used to guide the cut items from the food block away from the knife and into the shaping gripper. This can also be advantageous, for example, if the shape of the cut items caused by cutting are to be retained as far as possible, as may be the case for scraped cheese rosettes on a piece of Tête de Moine cheese.

In one embodiment of the invention, which may be combined with any other embodiment previously mentioned or yet to be mentioned, provided they do not contradict each other, the separating device is sheet-shaped or wedge-shaped and movable perpendicular to the first axis of rotation. Alternatively, the cutting device is designed as an angled plate that can be tilted relative to the first axis of rotation. The cutting and shaping device comprises a cutting device drive with which the movement of the cutting device is carried out under the control of the control unit.

The movement of the separating device can, for example, be a linear back and forth movement or a tilting movement with which the separating device is positioned relative to the first axis of rotation. In particular, the position of the separating device is controlled as a function of the position of the knife and also as a function of the position of the shaping gripper.

Alternative shapes of the separating device are possible as long as they allow the separating device to be positioned relative to the knife and the shaping gripper and to guide cut-off product from the food block or the knife towards the receptacle of the shaping gripper. A scraper edge, as used for guiding in a sheet metal or wedge shape, is not necessarily provided. Alternative shapes can be provided if, for example, a specific shape of the cut items are to be achieved additionally by means of a separating device, or if the dimensions of the food block, the knife and the shaping gripper and/or their drives require an alternative shape.

Even if the term sheet metal or sheet metal form is used in this context, it is possible for the separator to be made of a different material. A separator made of plastic, for example, or a separator made of a combination of plastic and metal areas is also suitable. Other materials such as rubber, foil-coated or coated workpieces or similar are also conceivable. The same applies to separators of other shapes such as wedge-shaped or similar.

In one embodiment of the invention, which may be combined with any other embodiment previously mentioned or yet to be mentioned, provided they do not contradict each other, the receptacle comprises a centering pin. The centering pin extends substantially perpendicularly from the support surface of the receptacle in the direction of the slicing knife along the first axis of rotation.

This arrangement and alignment of the centering pin, receptacle and axis of rotation is particularly suitable for scraping rosettes from a Tête de Moine cheese wheel attached to the receptacle, for example. The cheese wheel is placed on the centering pin so that it holds the cheese wheel in position on the receptacle, even if the receptacle rotates for scraping.

The centering pin can be manufactured in one piece with the receptacle, or it can be manufactured as a separate workpiece and attached to the receptacle. If the centering pin is made in one piece with the receptacle, It can be made from the same material. Alternatively, it is possible for the centering pin to be formed from a different material than the receptacle. A suitable material can be a metal or plastic, for example. The choice of material for the centering pin can, for example, be based on the properties of the food product block to be placed on it. For example, it may be intended that the centering block has a non-stick coating or additionally or alternatively comprises retaining structures on the surface of the centering pin.

In one embodiment of the invention, which can be combined with any other embodiment mentioned above or yet to be mentioned, provided they do not contradict each other, the receptacle with the centering pin is designed to pivot out of the first axis of rotation.

In this embodiment, loading and unloading the receptacle with a food block can be simplified,

In one embodiment of the invention, which may be combined with any other embodiment previously mentioned or yet to be mentioned, provided they do not contradict each other, the cutting and shaping device comprises a monitoring device with which the presence of a food block positioned on the receptacle can be detected. The monitoring device is controlled by the control unit.

Such a monitoring device is provided in particular for embodiments in which the receptacle is designed to rotate about the first axis of rotation.

Various monitoring devices are conceivable for detecting whether or not a food block is present on the receptacle. For example, a suitable monitoring device can be a capacitive sensor, a reed switch, an optical sensor, light barrier or light sensor, distance sensor or proximity sensor or comprise one or more such sensors for detecting the presence of a food block and have additional, for example mechanical elements. This can be, for example, a bolt with spring return, which protrudes beyond the support surface and is pushed backwards by a food block placed on it. In such a detection position, the bolt can be detected by a sensor. A vacuum detection device is also possible, for example, with which a vacuum can be created on the underside of the food block by means of an attached food block, which in turn can be detected by a sensor. A monitoring device with a detection wheel, as described later, is also possible.

In particular, it may be provided that it is possible to use a monitoring device not only to detect the presence of a food block itself, but also to detect a faulty food block that does not (or no longer) rotate evenly on the receptacle.

In one embodiment of the invention, which may be combined with any other embodiment previously mentioned or yet to be mentioned, provided they do not contradict each other, the monitoring device comprises a detection wheel which is designed to rotate about a third axis of rotation. In this case, the third axis of rotation extends parallel to the first axis of rotation. In addition, the detection wheel is designed to move with its third axis of rotation parallel to and perpendicular to the first axis of rotation.

In this embodiment, the detection wheel is used to check whether a food block placed on the receptacle is rotating correctly during operation of the cutting and shaping device. For this purpose, the detection wheel can be moved in the direction of the first axis of rotation until it impacts the food block. It may be provided to control the impact pressure by controlling the path of the detection wheel in the direction of the axis of rotation and as a function of the circumference of the food block, for example by means of a control unit. The pressure is selected in such a way that when the food block is rotated through the receptacle, the food block in turn rotates the detection wheel. The detection wheel therefore rotates with the rotation of the food block, namely in the opposite direction. If the food block is intact and rotates on the receptacle as specified, the detection wheel rotates in the same way. If, on the other hand, the food block is broken, for example, the rotation of the detection wheel is altered. This in turn can be detected either by operating personnel or by a sensor system, and the production process can be stopped, for example by stopping the rotation of the receptacle.

In one embodiment of the invention, which can be combined with any other embodiment previously mentioned or yet to be mentioned, provided they do not contradict each other, the monitoring unit comprises a sensor system with which a rotation of the detection wheel can be detected,

It may be provided that the sensors can be used to detect the rotation of the rotary wheel, as indicated above. Suitable sensors can be, for example, optical sensors such as light barriers or light scanners, or proximity sensors based on the principle of induction, for example, or reed switches.

Light barriers can, for example, detect selected structures of the detection wheel that change as a result of rotation. Examples include spokes in the detection wheel or an asymmetrical signal transmitter coupled to the detection wheel, such as a metallic half disk or other alternative asymmetrically shaped signal transmitters that rotate together with the detection wheel. This can be achieved, for example, by mounting the half disk on the same axis of rotation as the rotating wheel. The sensor system is arranged in such a way that it monitors the rotation of the half disk: If the half disk passes the sensor area during rotation, the sensor receives a signal. If the half disk is outside the sensor range, the sensor does not receive a signal. Alternatively, a capacitive sensor is also suitable for such a detection setup.

When the food block is properly rotated, the sensor receives a signal at regular intervals, which it transmits to the control unit. The cycle at which the food block rotates correctly is stored in the control unit.

If the rotation of the half-disk detected by the sensor deviates from a correct rotation, the control unit can recognize a change in the detected signals from the sensor. If, for example, the food block is broken or has become detached from the receptacle, the detection wheel no longer rotates or no longer rotates correctly, deviating sensor signals are forwarded to the control unit. The control unit can then trigger the detection wheel to be moved away from the receptacle or the attached food block and/or the receptacle is no longer rotated,

A sensor system with detection wheel designed in this way is particularly suitable for use with a cheese block, for example a Tête de Moine block.

Alternatively, it may be possible to design the monitoring unit in such a way that the direction of rotation of the food block can also be detected, for example by means of asymmetrically designed signal triggers in the sensor system.

Alternatively, a laser sensor can be used to control the cutting process on the top of the food block, for example, by moving the laser sensor at a defined distance from the top edge during the process. As long as the distance between the laser beam and the top edge remains the same, it is confirmed that the cut items are being separated from the food block. However, if the laser beam hits the food block, for example, this can be an indication that the food block is not rotating with the receptacle and the knife is therefore unable to cut off the food. A sensor positioned in this way thus detects faulty material removal.

In one embodiment of the invention, which may be combined with any other embodiment previously mentioned or yet to be mentioned, provided they do not contradict each other, the monitoring device comprises a laser which is connected to the knife or the knife drive in a fixed position and which is aligned with a laser point which is located above the top of the food block when the food block is in place and when the knife has cut it off correctly.

In this embodiment, the laser would detect the upper side of the food block instead of the laser point if, for example, the food block rotates on the receptacle and, accordingly, no cut items can be separated with the knife. In this situation, the knife would be guided into the food block during continuous operation, as it is not reduced in size due to the lack of separation of cut items. Accordingly, the upper side remains at the same height. Due to the fixed-position coupling of the laser with the knife, the laser is also guided further in the direction of the receptacle, which means that the laser point is not above the top of the food block, but in the food block. This means that the laser detects the food block instead of an empty spot if a section is missing, which can be evaluated by the control unit in terms of signals.

In one embodiment of the invention, which can be combined with any other embodiment previously mentioned or yet to be mentioned, provided they do not contradict each other, the cutting and shaping device comprises a holding element on the receptacle, which is designed as a vacuum device for sucking a food block placed on the receptacle. The vacuum device comprises at least one vacuum sensor for detecting a vacuum on the receptacle. Such a combination of vacuum device and vacuum sensor can also serve as a monitoring device, as the control unit can recognize that a food block is in place when a vacuum is applied, while it can conclude that no food block is in place (or is not placed correctly) if no vacuum is created.

Such a vacuum device can be used to ensure that a food block placed on the receptacle remains on the receptacle, even if the latter rotates for operation. A vacuum device can be included as a supplement or alternative to other holding elements as discussed above. For example, it is provided that the vacuum device can be used to hold the food block itself on the receptacle, while additional holding elements are provided on the support surface of the receptacle, with which the food block is held in the desired position on the support surface.

It may be suitable to install both the vacuum device and the detection device with sensors in a cutting and shaping device for safe operation.

In one embodiment of the invention, which can be combined with any other embodiment previously mentioned or yet to be mentioned, provided they do not contradict each other, the cutting and shaping device is designed for the automated production of shaped Tête de Moine rosettes.

The various elements and embodiments of a cutting and shaping device discussed above have already been explained by way of example for the operation of the system with a scraping knife and a shaping gripper that is specially adapted to a rosette shape. In particular, the orientation of the knife, in which the cutting edge extends perpendicularly to the first axis of rotation and can also be moved parallel to the first axis of rotation for cutting, is particularly suitable for scraping Tête de Moine rosettes. For this purpose, the receptacle of the shaping gripper is shaped like a truncated cone.

The invention also relates to a shaping gripper for the automated production of shaped Tête de Moine rosettes in one or more embodiments of the cutting and shaping machine described in more detail above. The corresponding shaping gripper comprises at least two gripper jaws, each having an inner side, which are movable relative to each other. As previously discussed, the gripper jaws with their inner sides thus jointly form a Tête de Moine rosette-shaping receptacle.

In one embodiment of the invention, which can be combined with any other embodiment previously mentioned or yet to be mentioned, provided they do not contradict each other, the shaping gripper is attached to a rotating device. The features and variants of the rotating device described above in connection with the cutting and shaping machine also apply in this context. By means of the rotating device, the shaping gripper can be moved relative to the first axis of rotation of the cutting and shaping device. The rotating device is designed as a rotating wheel, which comprises two or more holding positions for attaching further shaping grippers. The rotary wheel is operatively connected to a rotating device drive in an embodiment as described above.

The production of a large number of Tête de Moine rosettes can take place in an automated and efficient manner using a rotary wheel of this type. For each new rosette scraped off with the knife, a shaping gripper with an empty receptacle can be provided at close intervals. Once the knife has been withdrawn and the rosette inserted into the assigned shaping gripper, the now occupied shaping gripper can be turned away from the “active” position close to the knife by means of the rotary wheel and a new, empty shaping gripper can be swung into the active position immediately. The knife can then immediately penetrate the cheese wheel again and scrape off the next rosette without having to wait for the originally occupied shaping gripper to bring the rosette into its final shape, release it (for example into a prepared tray) and return it to the active position.

For example, it may be provided that a gripper wheel with four crosswise arranged shaping grippers can be installed in the cutting and shaping device for Tête de Moine rosettes. An empty shaping gripper on the knife can be pivoted into the active position by turning the gripper wheel 90° each time. The time between each knife incision in the cheese wheel for turning a rosette can thus be minimized to the time required for the 90° rotation.

The features of the above-mentioned embodiments of the cutting and shaping device can be used in any combination as long as they do not contradict each other. Range specifications include the specified limit values,

The invention also relates to a method for producing shaped cut items of a food block. It comprises the following steps:

Providing a cutting and shaping device in one of the embodiments described above or a combination thereof. It may be provided, in addition to the receptacle, the shaping gripper and the knife, to integrate further elements described here into the cutting and shaping device as required.

Placing a food block on the support surface of the receptacle. Depending on the design of the support surface, one or more holding elements can be provided on or at the support surface to improve the hold of the food block.

Moving the knife and/or the receptacle towards each other under the control of the control unit until the knife pierces into the top of the attached food block. The penetration depth determines the thickness of the severed cut items. It can vary depending on the desired shape and type of food to be processed and can be stored in the control unit, for example. It may be provided, for example, that by selecting the type of food block, the control unit can automatically trigger settings such as the movement of the knife (for the penetration depth), the time of penetration and movement of the knife during the cutting process (for the length of the cut items), the speed of the receptacle and similar.

Triggering a rotational movement of the receptacle about the first axis of rotation and continuous movement of the knife and/or the receptacle towards each other, thereby cutting off a cut item from the top of the attached food block. It may be provided that the knife is moved continuously in the direction of the receptacle in order to ensure continuous piercing of the food block. The piercing can be checked by means of additional sensors, for example.

Positioning the shaping gripper relative to the surface of the attached food block and picking up and gripping the cut item in the shaping gripper, whereby the cut item is formed. It may be provided that the shaping gripper is also positioned opposite the knife, in particular its cutting edge, in order to securely hold the cut item. The alignment of the shaping gripper, in particular the gripper jaws and their receptacle, can take into account various aspects such as the shape and position of the freshly cut-off sliced product, the shape and dimensions of the receptacle in the shaping gripper, as well as the alignment of the opening of the receptacle when the gripper jaws are moved apart. As soon as the cut items are picked up in the receptacle of the shaping gripper, the gripper jaws are moved towards each other as described above and thus brought into a closed state. The cut Items are shaped by the resulting narrowing of the receptacle.

In one embodiment of the method, which can be combined with any other embodiment mentioned above or yet to be mentioned, provided they do not contradict each other, the receptacle is rotated about the first axis of rotation for the separation process, and for piercing the knife is moved along the first axis of rotation in the direction of the receptacle until the cutting edge pierces the food block. In this alignment of the knife to the receptacle, cut items can be efficiently separated from the food block without having to accept too much material loss.

In one embodiment of the method, which may be combined with any other embodiment previously mentioned or yet to be mentioned, provided they do not contradict each other, the knife is moved away from the food block to interrupt the cutting off of cut items. It is particularly advantageous if the knife is retracted along the first axis of rotation, i.e. moved away from the receptacle. It may be provided to specify the length of the path for this backward movement in the control unit.

In one embodiment of the method, which may be combined with any other embodiment previously mentioned or yet to be mentioned, provided they do not contradict each other, the shaping gripper comprises two gripper jaws which are movable relative to each other. The gripper jaws are positioned opposite the knife during the cutting off of cut items in order to directly pick up the cut-off items. For this purpose, the gripper jaws each comprise an inner side, with which they jointly form a shaping receptacle for cut-off items cut from a block of food. The gripper jaws are moved away from each other to pick up the cut items cut off by the knife, while they are moved towards each other to shape the received cut items.

By moving away from each other, the shaping gripper is brought into an open state, as described above. It may be provided that the distance by which the gripper jaws are spaced apart in the open position can be stored in the control unit. The distance can be adapted to the type of food and the shape and size of the cut items being produced.

By moving towards each other, the shaping gripper is brought into the closed state, as also described above. It may be provided to store in the control unit how far the gripper jaws are moved towards each other, and thus how the receptacle is ultimately in the closed state. The shape and dimensions of the receptacle are preferably adapted to the items to be cut.

In one embodiment of the method, which can be combined with any other embodiment mentioned above or yet to be mentioned, provided they do not contradict each other, the shaping gripper comprises an ejector with a support surface. Cut items, which are received in the shaping gripper, lie on the support surface and/or are discharged from the shaping gripper by means of the ejector.

The descriptions above or later in connection with the ejector can also be used here.

In one embodiment of the method, which may be combined with any other embodiment mentioned above or yet to be mentioned, provided they do not contradict each other, the picked-up and formed cut items are transported away from the food block by means of the shaping gripper.

It may be provided here that the shaping gripper is functionally connected to an additional movement unit, such as a rotating device, which is explained in more detail above or in the figures. The advantage is that in this way the shaped cut items do not have to be removed from the shaping gripper directly at the knife, but can be removed at a different location. It may be provided in particular that immediately after the shaping gripper loaded with cut items has been moved away, the now free position in front of the knife can be occupied by an unloaded shaping gripper. This is possible, for example, by means of a rotating device with several shaping gripper positions, as presented in connection with FIG. 12.

In one embodiment of the method, which may be combined with any other embodiment previously mentioned or yet to be mentioned, provided they do not contradict each other, the cutting and shaping device comprises a separating device for guiding cut-off items from the knife into the shaping gripper. To take up the cut items into the shaping gripper, the knife is retracted so that the cutting process is interrupted, and at the same time the separating device is moved in the direction of the shaping gripper so that the cut items cut off by the knife are guided into the shaping gripper under the action of the separating device,

The descriptions of the cutting device in connection with the cutting and shaping device or the figures can be applied directly here, in particular the explanations regarding the design of the cutting device.

In one embodiment of the method, which may be combined with any other embodiment previously mentioned or yet to be mentioned, provided they do not contradict each other, the cutting and shaping device comprises a monitoring device with a detection wheel and a sensor system. The rotation of the attached food block is monitored by moving the detection wheel in the direction of the food block until it acts on the food block. The resulting rotation of the detection wheel is detected by the sensor system.

In this embodiment, the rotation of the food block is checked indirectly via the rotation of a detection wheel triggered by the rotation, which in turn can be checked by sensors. Alternatively, as described above, it may be possible to check the food block or its rotation directly using sensors,

In one embodiment of the method, which may be combined with any other embodiment previously mentioned or yet to be mentioned, provided they do not contradict each other, the food block is a Tête de Moine cheese block, and Tête de Moine rosettes are scraped and formed with the cutting and shaping equipment.

In one embodiment of the method, which may be combined with any other embodiment previously mentioned or yet to be mentioned, provided they do not contradict each other, the food block used is a Tête de Moine cheese block and the cutting and shaping equipment is adapted to cut and shape Tête de Moine rosettes.

In this embodiment of the method, the cutting and shaping device is designed as described above and below in such a way that rosettes of the Tête de Moine cheese block are scraped off, which correspond to the guidelines of the requirement specifications of the Tête de Moine, Fromage de Bellelay variety organization; available at www.tetedemoine.ch.

### BRIEF DESCRIPTION OF THE FIGURES

Embodiments of the invention are explained in more detail below with reference to figures (FIG.). These are selected for illustrative purposes and their description is not to be understood as limiting, wherein:

FIG. 1 shows a schematic, spatial overview of a cutting and shaping device in a simple embodiment;

FIG. 2 shows a schematic, spatial overview of a cutting and shaping device as shown in FIG. 1 with an attached food block;

FIG. 3 shows a schematic, spatial view of a receptacle of cutting and shaping device with a food block and shaping gripper attached;

FIG. 4 shows a schematic, spatial view of the receptacle from FIG. 3 with knife;

FIG. 5 shows a schematic, spatial view of the receptacle from FIG. 3 with shaping gripper and knife;

FIG. 6 shows a schematic, spatial oblique view from the front of an exemplary shaping gripper with two gripper jaws;

FIG. 7 shows a schematic, spatial oblique view from the front of the two gripper jaws from FIG. 6 with an ejector;

FIG. 8 shows a schematic, spatial side view of the ensemble of gripper jaws and ejector as shown in FIG. 7;

FIG. 9 shows a schematic, spatial view of a shaping gripper with two gripper jaws and movement mechanism as well as an ejector with guide rod for the movement between the gripper jaws, in a view from the front and slightly from above;

FIG. 10 shows a schematic, spatial view of a shaping gripper in a further embodiment, as viewed diagonally from the side;

FIG. 11 shows a schematic, spatial view of a shaping gripper with ejected ejector and cut items just ejected;

FIG. 12 shows a schematic, spatial view of a rotating device for the attachment of four shaping grippers, with one of the shaping grippers being positioned in relation to a centering pin of a receptacle with a food block attached;

FIG. 13 shows a schematic, spatial view of a knife with an exemplary separating device;

FIG. 14 shows a schematic, spatial view of a knife with an alternative separating device;

FIG. 15 shows a highly schematized sectional drawing of a receptacle with alternatively shaped holding surfaces and various possible positions of the knife;

FIG. 16 shows a highly schematized sectional drawing of a receptacle with alternative holding elements;

FIG. 17 shows a highly schematized sectional drawing of a receptacle with a monitoring device;

FIG. 18 shows a schematic section of a cutting and shaping device with an alternative monitoring device in a spatial view;

FIG. 19 shows a schematic side view of a cutting and shaping device as shown in FIG. 18, additionally with a rotary wheel for four shaping grippers;

FIG. 20 shows a highly schematized overview of the function of a monitoring device as shown in FIG. 18;

FIG. 21 shows a highly schematized overview of the function of a further, alternative monitoring device;

FIG. 22 shows a schematic overview of possible method steps in the production of shaped cut items by means of a cutting and shaping device; and

FIG. 23 shows a highly schematized view of method steps for gripping and shaping cut items.

### DETAILED DESCRIPTION OF THE FIGURES

The present invention relates to a cutting and shaping device with which cut items can be automatically separated from a food block and shaped. Although the cutting and shaping device is also suitable for other types of food, the exemplary design of the cutting and shaping device for the production of Tête de Moine rosettes is referred to for better illustration.

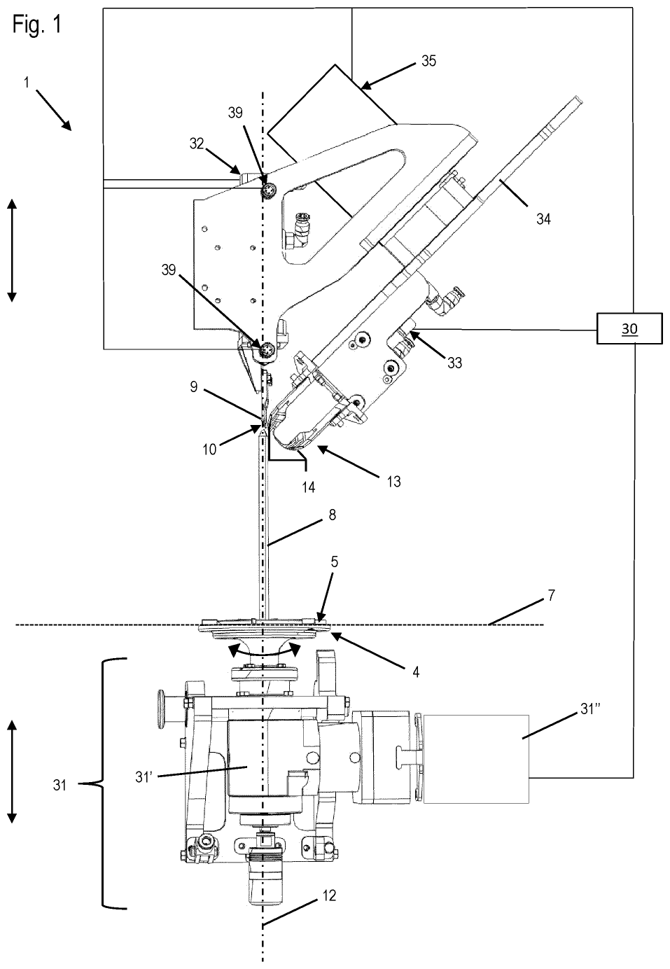

FIG. 1 shows a cutting and shaping device 1 in a simple embodiment, which comprises a receptacle 4, a knife 9 and a shaping gripper 13. In this embodiment, the receptacle 4 can be rotated about a first axis of rotation 12 for the automated production of shaped cut items. The rotational movement is made possible by means of a receptacle drive 31. FIG. 1 shows a receptacle drive with a gear 31′ and a motor 31″. The first axis of rotation 12, about which the receptacle 4 rotates, is shown as a dotted line.

In this embodiment, the receptacle 4 comprises a flat support surface 5 and a centering pin 8. In this embodiment, the support surface 5 is arranged perpendicular to the first axis of rotation 12 and extends in a first plane 7. When the receptacle 4 rotates about the first axis of rotation 12, the support surface moves in this first plane 7.

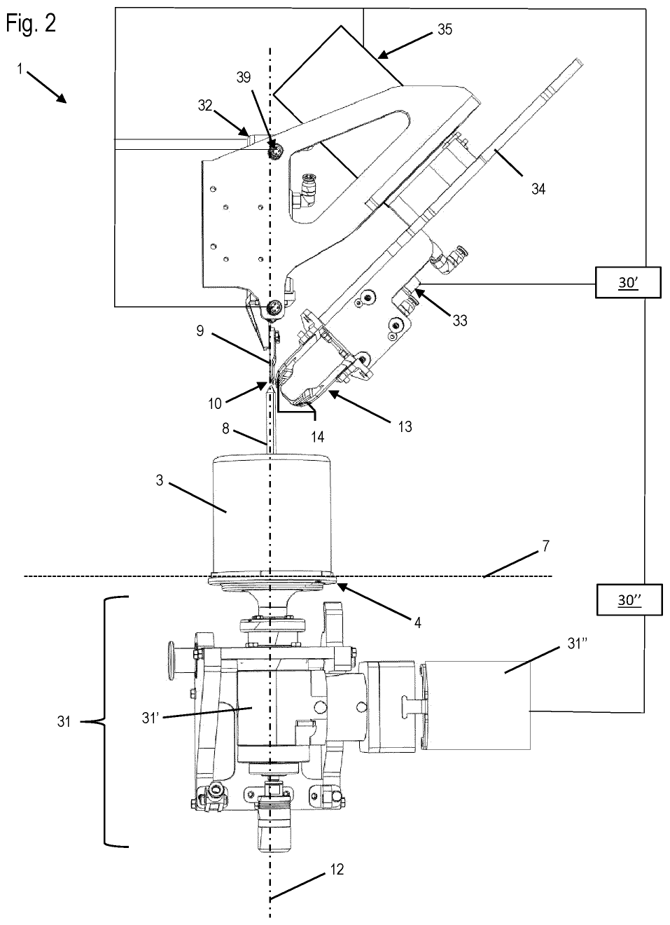

The centering pin 8 extends along the first axis of rotation 12, so that when the receptacle 4 is rotated, the centering pin 8 is also rotated accordingly about the first axis of rotation 12. A food block 3, for example a Tête de Moine cheese block, can be placed on the centering pin 8 (see FIG. 2).

FIG. 1 shows the knife 9 from the side. The cutting edge 10 is oriented downwards in the direction of the support surface 5. It is advantageous if the cutting edge does not extend through the first axis of rotation 12 and also does not contact the centering pin 8 during a movement in the direction of the receptacle 4. In this way, it can be prevented that during operation of the cutting and shaping device 1 shown, i.e. when a food block 3 is positioned on the receptacle 4, the receptacle 4 rotates and the knife 9 is pushed in the direction of the receptacle 4 to cut off the cut items 2 while the rotation is running, the system is blocked by the contact of the knife 9 with the centering pin 8. In order to cut off cut items 2 from a food block 3 placed on the receptacle, the cutting edge 10 of the knife therefore extends laterally away from the centering pin 8, for example parallel to the first plane, as shown in FIG. 1.

The movement of the knife 9 along the first axis of rotation 12 can be automated by means of a knife drive 32.

The shaping gripper 13 comprises two gripper jaws 14 that can move against each other and whose inner sides 15 form a receptacle 16 for the cut items 2. The shaping gripper is aligned with its receptacle 16 in relation to the knife 9, in particular to its cutting edge 10. The alignment is such that the cut items 2, which are separated from the food block 3 at the cutting edge 10, can be guided from the cutting edge 10 into the receptacle 16 in such a way that the cut items 2 are brought into the desired shape in the receptacle 16 by moving the gripper jaws 14 towards each other.

The shaping gripper 13 can be moved along the first axis of rotation 12 in the same way as the knife, i.e. it is guided axially. Thus, when the knife for piercing is moved in the direction of the receptacle 4 during the rotation of an attached food block 3, the shaping gripper 13 can be moved axially with the knife 9. In this way, cut items 2 can be continuously picked up and formed in the shaping gripper 13 as the cut items 2 are continuously cut off and the food block 3 is reduced in size. The movement of the shaping gripper 13 along the first axis of rotation 12 can be automated by means of a shaping gripper drive 33. The axial guidance of the shaping gripper 13 and the knife 9 is not shown here for reasons of clarity,

Alternatively, it may be provided that to allow the knife 9 to pierce an attached food block 3, the knife 9 (and similarly the shaping gripper 13) is not moved in the direction of the knife 9, but Instead the receptacle 4 is moved in the direction of the knife 9, or the knife 9 (and shaping gripper 13) and receptacle 4 can be moved towards each other on both sides. However, since this embodiment is associated with increased technical complexity, it may be less preferred. The various options for movement are indicated by arrows.

In the embodiment shown, the shaping gripper 13 has a distal end which can be opened and closed. The distal end is opposite the side on which the shaping gripper 13 is attached to a rotating device 34 for rotating the shaping gripper 13 in this embodiment. By means of the rotating device 34 and a rotating device drive 35, the shaping gripper can be rotated away from the knife 9 after picking up cut items 2, for example in order to place the then formed cut items 2 in a packaging tray (not shown). The rotating device 34 functions here as a suspension for the shaping gripper 13. The shaping gripper 13—together with the rotating device—can be moved axially along the first axis of rotation 12 by means of the shaping gripper drive 33.

Two sensors 29 are also shown, which are used to determine the position of the knife relative to the receptacle 4 (and thus indirectly the penetration depth when a food block 3 is positioned on the receptacle 4) and can be controlled by feedback to a control unit 30. The sensors 29 shown here are each a proximity sensor.

The cutting and shaping device 1 also comprises a control unit 30. The control unit 30 is functionally connected to the shaping gripper 13, the knife 9 and the receptacle 4, in particular to the shaping gripper drive 33, the receptacle drive 31 and the knife drive 32, so that the rotation of the receptacle 4, the movement of the knife 9 for piercing and the positioning of the shaping gripper 13 in relation to the knife 9 can be controlled automatically. In the embodiment shown, the rotating device drive 35 is also connected to the control unit 30. The functional connections of the individual elements of the cutting and shaping device 1 with the control unit 30 are shown in simplified form by means of lines.

FIG. 2 shows the cutting and shaping device 1 shown in FIG. 1 with an attached food block 3. It can be seen here that a food block 3 placed on the receptacle 4 almost completely presses against the support surface 5 in the mounted state. If the food block is smaller, it is possible that the support surface is only partially loaded.

Ideally, the food block 3 is placed approximately rotationally symmetrically on the centering pin 8 and on the receptacle 4. The centering pin 8 holds the food block 3 stable on the receptacle when it is rotated or stationary,

In contrast to the embodiment shown in FIG. 1, the cutting and shaping device 1 is divided into at least two separate control units 30′, 30″, which are functionally connected to each other. Alternatively, it is possible that each element of the cutting and shaping device 1 comprises its own control unit (30′, 30″, 30″′ etc.), which are, however, all interconnected and are controlled and coordinated, for example, by a central control unit 30.

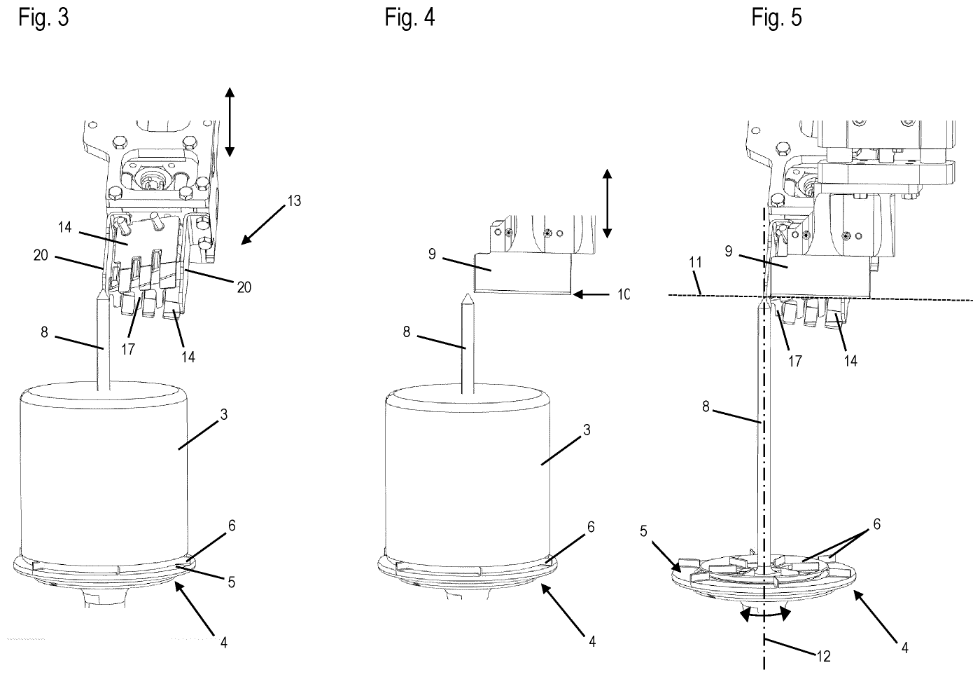

FIG. 3 shows a schematic view of a receptacle of a cutting and shaping device 1 with a food block 3 placed on the receptacle 4 and a positioned shaping gripper 13 from the side. The shaping gripper 13 is positioned laterally next to the centering pin 8. The movability of the shaping gripper 13 in this case is indicated by a double arrow; for the sake of clarity, the shaping gripper drive 33 is not shown, nor is the rotatability of the receptacle 4.

The support surface 5 of the receptacle 4 comprises various retaining means 6—in this case several webs that extend in the direction of the shaping gripper 13. The webs penetrate the attached food block 3, for example a block of cheese, from below and thus prevent the food block 3 from slipping on the support surface 5 when the receptacle 4 is rotated,

The shaping gripper 13 is made up of two gripper jaws 14, which have finger-shaped extensions at their distal end (i.e. opposite the side of the shaping gripper with which the shaping gripper is attached to a receptacle). Parts of an ejector 17 engage in the spaces between the finger-shaped extensions. The support surface 18 of the ejector 17 (see FIG. 14 or 16) and the insides of the gripper jaws 14 form a shaped receptacle 16. The receptacle 16 is laterally bounded by a respective limiting element 20. The limiting elements 20 are fixed to the receptacle so that they cannot move relative to the gripper jaws 14.

Cut items 2 that have been scraped, cut or planed from the food block 3 are picked up in the receptacle 16 when the shaping gripper 13 is open. If the shaping gripper 13 is closed, i.e. the gripper jaws 14 are moved towards each other, the receptacle 16 is reduced in size and the cut items 2 are thus brought into the desired shape. To eject the now formed cut items 2 into a package, for example, the shaping gripper 13 can be opened again and ejected from the receptacle 16 by means of the ejector 17, Since the ejector 17 has a correspondingly shaped support surface 18, the shape of the cut items 2 is not further affected by the ejection process. For the automated process, it is useful if the shaping gripper 13 is moved away from the “catching position” for ejection and is advantageously moved to an “unloading position” in which the cut items 2 are collected accordingly (not shown).

FIG. 4 shows a schematic view of the receptacle from FIG. 3, for the sake of clarity without the shaping gripper 13, but with knife 9. It can be seen here that the knife 9 is positioned in such a way that the cutting edge 10 cannot contact the centering pin 8 when the knife 9 is moved in the direction of the receptacle 4 during operation. If the receptacle 4 does not include a centering pin 8, this position of the knife 9 is not necessary, but may still be desired in order to ensure uniform removal of material from the top of the food block 3. In such an embodiment, however, the knife 9 can alternatively also extend over the entire length of the receptacle 4 or the desired food block 3.

FIG. 5 shows a schematic view of the receptacle from FIG. 3 with the shaping gripper 13 and knife 9 from FIG. 4. The relative positioning of the cutting edge 10 of the knife 9 to the distal end of the shaping gripper 13 is clearly visible here. Thus, in this embodiment, the edge of the distal end of the shaping gripper 13 is aligned approximately parallel to the cutting edge 10 of the knife 9. The length of the cutting edge 10 and the length of the receptacle 16 of the shaping gripper are also matched to one another, so that cut-off items 2 can be picked up completely and almost immediately after the cutting process by the knife 9 into the shaping gripper 13. FIG. 5 indicates that in this embodiment, the cutting edge 10 of the knife 9 extends in a second plane 11. If the knife 9 and the shaping gripper 13 are moved in the direction of the receptacle for separating the cut items, this second plane 11 is moved virtually, and the arrangement of the cutting edge 10 to the distal edge of the shaping gripper 13 remains the same in relation to the second plane 11.

For the sake of clarity, no food block 3 is shown in FIG. 5, so that the design of the support surface 5 can be seen. A plurality of holding elements are attached to the support surface 5, each of which extends in the direction of the knife 9 or shaping gripper 13 perpendicular to the support surface 5. There are both radially arranged webs and, in this case, a web extending around the centering pin 8. With regard to the number and arrangement of the holding elements 6, it is important to ensure that as much support as possible is provided without damaging the integrity of the food block 3 too much. For example, this can prevent the food block 3 from breaking when triggered by the holding elements 6. The consistency of the food block 3 is also taken into account—for example, different holding elements may be useful for a block of hard cheese than for a block of salami. As mentioned, for example, a circumferential clamping ring or grippers or claws engaging laterally on the food block 3 may be preferred as a less invasive holder.

The rotatability of the receptacle is indicated by a curved double arrow.

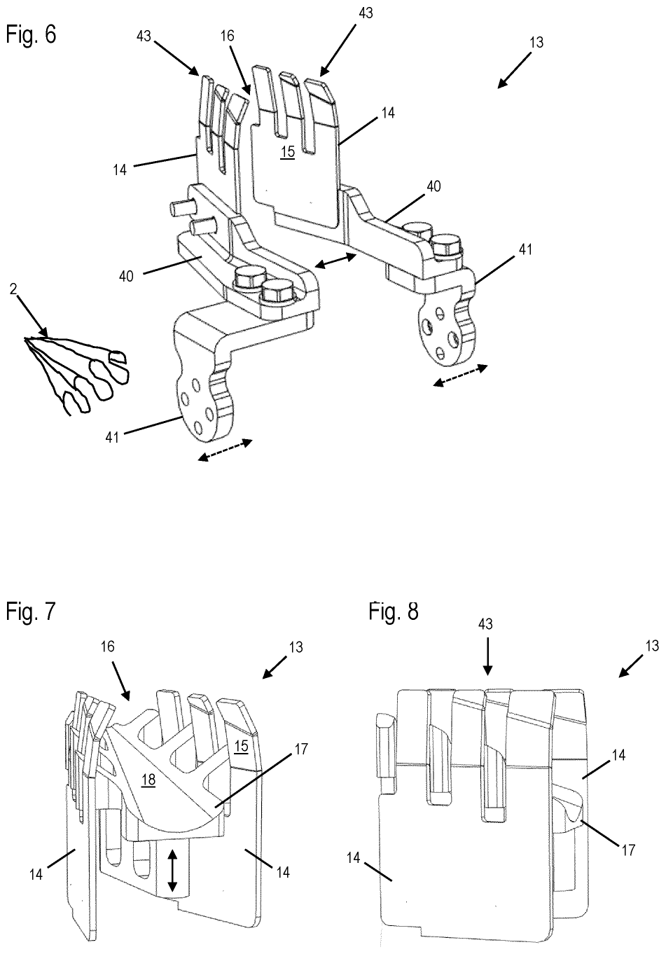

FIG. 6 shows a schematic representation of a shaping gripper 13 with two gripper jaws 14 in a preferred embodiment. Each gripper jaw 14 has a distal end 43 or a distal edge with which the shaping gripper 13 can be positioned relative to the knife 9. Each distal end 43 or the corresponding end region has a finger shape in this embodiment. In particular, each gripper jaw has finger-shaped extensions with recesses between the fingers. As can be seen in FIG. 7, complementary extensions of an ejector 17 can move into these recesses if this is provided. In this way, a guided movement of an ejector 17 between the gripper jaws 14 is possible. With regard to the ejector 17, its outer edges of the support surface can alternatively also be designed without such extensions.

Each gripper jaw 14 is specially shaped, wherein the shaping is determined in particular by the inner sides 15 of the gripper jaws 14. Together, the inner sides 15 of the gripper jaws 14 form a shape with which cut items 2, which are picked up in the shaping gripper 13, can be formed as soon as the gripper jaws 14 are brought into a closed state. In this case, the gripper jaws 14 are not used purely for “gripping” material in order to transport it safely from A to B; they therefore do not function purely as tongs. Gripping too tightly, i.e. applying pressure to the material picked up by the insides 15 of the gripper jaws, is actually undesirable, as there is a risk that the cut items will be deformed in such a way that they deviate from the intended shape and may no longer look appealing to a buyer. It should be recognized here that a semi-solid or solid food product is involved which, depending on the type, may crumble or squash if it is compressed too tightly.

FIG. 6 shows an example of how the gripper jaws can be designed to be movable. For example, the proximal end of a gripper jaw 14 is attached to its own jaw receptacle 40. Here it is possible, for example, that the attachment is non-detachable, such as a welded connection, or alternatively the connection can be detachable, for example via a screw connection. A detachable connection can be particularly advantageous if it is provided that the gripper jaw(s) 14 should be replaced in an existing cutting and shaping device, for example for different foods, different forms for one type of food, or for a repair. Alternatively, a gripper jaw 14 can be designed as an integral workpiece with the jaw receptacle 40.

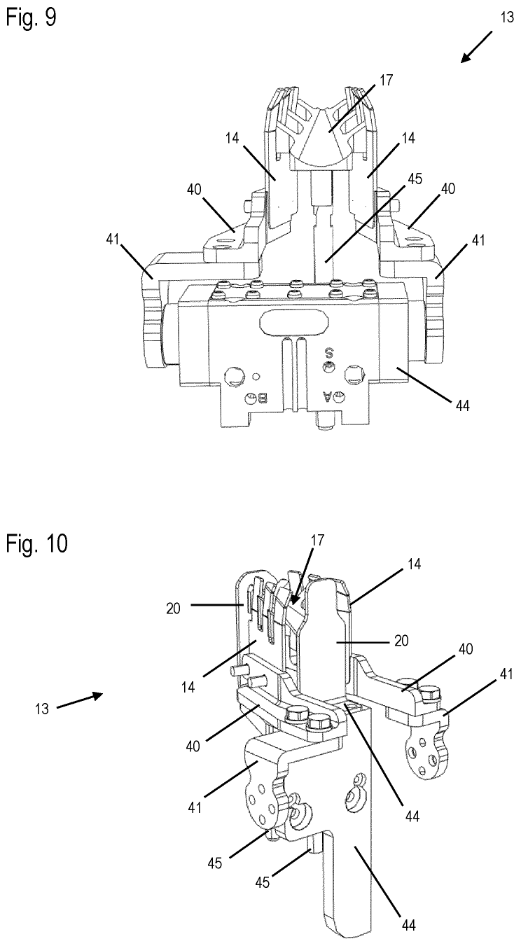

The jaw receptacle 40 is in turn connected to an adapter plate 41. This plate establishes the connection to a movement unit 44 for the respective gripper jaw 14 (see also FIG. 9).

In the embodiment shown, the gripper jaws 14 are designed in such a way that they function as parallel grippers. Alternatively, the gripper jaws 14 can be moved as angular grippers (not shown). The advantage of a parallel gripper is that only one gripper jaw 14 may need to be movable while the other is stationary, Deviating from the embodiment shown here, Instead of a left and a right gripper jaw 14, for example, it may be provided that each gripper jaw 14 is formed by two or more jaw parts which, for example, give the desired shape to the inner receptacle 16 by different movements in the direction of the opposite gripper jaw(s) (not shown). In the embodiment shown, each gripper jaw 14 is in one piece.

The direction of movement of each gripper jaw 14 is shown here for the adapter plate 41. A double arrow is shown for each gripper jaw 14, since in this embodiment each gripper jaw 14 can be moved back and forth in the indicated directions. If the gripper jaws 14 are moved away from each other accordingly, the shaping gripper 13 can be brought into an open state; the gripper jaws 14 are spaced apart from each other at their distal ends in such a way that cut items 2, which were previously separated from the food block 3 by the knife 9, can be brought into or out of the receptacle 16 between the gripper jaws 14. The control unit controls the maximum distance between the gripper jaws 14. If the gripper jaws 14 are moved towards each other, the shaping gripper 13 is brought into a closed state. Here, the gripper jaws 14 are positioned at a predetermined minimum distance from each other. This minimum distance is selected in such a way that when the shaping gripper 13 is moved, even when the gripper jaws 14 are closed, the picked-up cut items 2 do not fall out of the receptacle 16. For example, the corresponding path lengths for the back and forth movements can be stored in the control unit 30 in order to bring the shaping gripper 13 into the closed or open state.

Shown here is an example of cut items 2, such as those produced when scraping Tête de Moine rosettes. Details on the production of Tête de Moine rosettes can be found in the requirement specifications of the Tête de Moine, Fromage de Bellelay variety organization. Explicit reference is made to Article 3, which stipulates that the rosettes must be scrapable: “The rosettes produced with a Girolle or similar device must be compact. Rosettes are understood to mean that the Tête de Moine is not usually cut, but scraped with the Girolle or a similar device and formed into rosettes as shown on the label in accordance with Article 20 (see requirement specifications). A cutting and shaping device is preferably designed in such a way that rosettes can be scraped according to these specifications and automatically formed with the shaping gripper 13 and subsequently deposited.

FIG. 7 shows a schematic representation of the two gripper jaws from FIG. 6 with an ejector 17 positioned between the gripper jaws 14 in an oblique view from the front. The ejector 17 has a support surface 18 facing towards the distal end. Cut items 2, which have been separated from a block of food such as a Tête de Moine cheese and transferred to the shaping gripper, come to rest on this support surface 18. In this embodiment, the ejector 17 has finger-shaped extensions that engage in the recesses of the gripper jaws 14. If the ejector 17 is moved up and down in the receptacle 16 of the shaping gripper 13 (i.e. between the distal end 43 and the proximal end), it is guided in its movement by the recesses. If cut items 2 are picked up and the gripper jaws 14 are brought into the closed state, the support surface 18 also forms part of the shaping surface.

This can also be seen in FIG. 8, in which the ensemble of gripper jaws 14 and ejector 17 is shown in a schematized side view. In particular, these two figures show the conical shape of the receptacle 16, which is particularly suitable for the production of Tête de Moine rosettes. FIG. 8 also clearly shows the distal end 43, which is aligned with the cutting edge 10 of the knife 9. Preferably, the alignment is carried out in such a way that the edge extends parallel or approximately parallel to the cutting edge of the knife 9. This is particularly advantageous for the production of Tête de Moine rosettes, as the naturally formed rosette shape can be optimally used for further processing by aligning the shaping gripper.

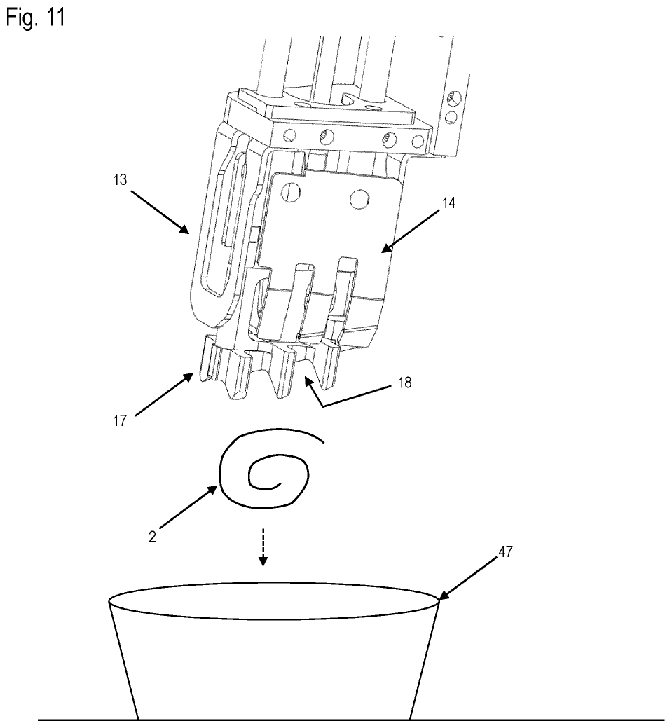

FIG. 9 shows a schematic representation of a shaping gripper 13 with a movement mechanism 44 for moving the gripper jaws 14 towards and away from each other in a front view slightly from above. In addition, the ejector 17 is shown with a guide rod 45, which establishes the connection for a drive of the ejector (not shown). By means of such a drive, the ejector 17 can be moved up and down between the gripper jaws 14. If the ejector 17 is positioned at the bottom, i.e. further away from the distal end 43, it forms part of the receptacle 16 for the cut items 2. If the ejector 17 is positioned at the top, i.e. at the distal end 43 of the shaping gripper, the cut items 2 can be discharged from the receptacle 16 (see also FIG. 11). For this purpose, the ejector 17 can even be moved out of the receptacle 16—in this case, it protrudes beyond the distal end 43 of the shaping gripper 13.

FIG. 10 shows a schematic view of a shaping gripper 13 in a further embodiment at an angle from the side. In this embodiment, the shaping gripper 13 additionally comprises two limiting elements 20, which laterally limit the receptacle 16 between the gripper jaws 14 and the ejector 17. The two gripper jaws 14 and the limiting elements 20 form side walls, so to speak, of the receptacle 16, while the support surface 18 of the ejector 17 forms the base. At the distal end 43, the shaping gripper 13 is finally open, wherein the opening is larger in the open state than in the closed state. In the closed state, the distal end 43 can only be narrowed by the gripper jaws 43 in such a way that inserted cut items 2 do not fall out during a gripper movement.

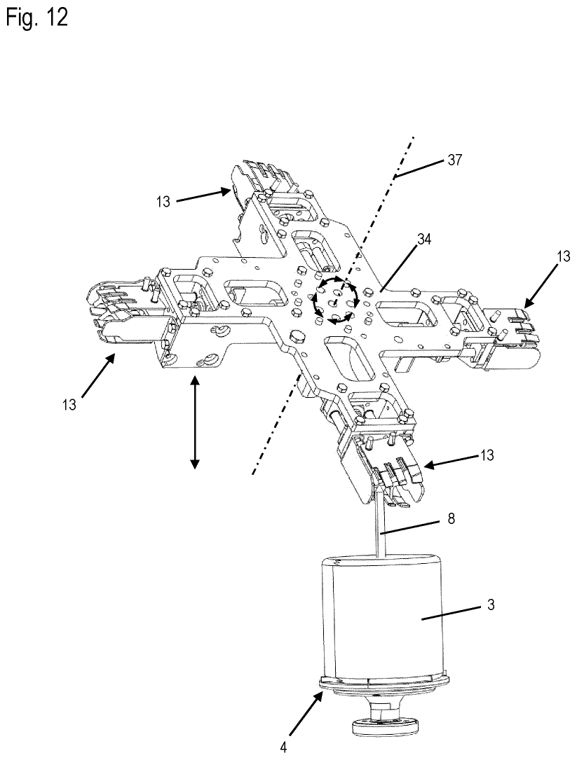

FIG. 10 shows additional fastening plates 44, with which the shaping gripper 12 is fastened to a receptacle, for example a rotating device 34 (see also FIG. 12), For the sake of clarity, the movement mechanism 44 for the gripper jaws 14 is not shown here.

One or more fastening plates 44 may be provided. In the embodiment shown here, two fastening plates 44 are shown—one which extends in a distal to proximal direction; this can be seen at the front. A further, second fastening plate 44 extends perpendicular to this front fastening plate 44 and is connected to it—the connecting elements themselves (e.g. screws) are not shown, The two limiting elements 20 are also attached to this second fastening plate 44.

In FIGS. 6 to 10, individual connecting elements are shown or not shown for the sake of clarity. It is within the knowledge of a person skilled in the art to select and implement the correct type of connection.

FIG. 11 shows a schematic view of a shaping gripper 13 with ejected ejector 17 and cut items 2 just ejected. Here, the shaping gripper 13 is aligned downwards in the direction of a container, for example a sales tray, so that the ejection of the ejector 17 causes the shaped cut items 2 to fall by gravity into the container 47 provided. As soon as the cut items 2 are in the container 47, further processing steps can take place, for example weighing the cut items 2 and/or packaging.

It is easy to see that the ejector 17 has moved so far out of the shaping gripper 13 that its support surface 18 is no longer in the receptacle 16 of the shaping gripper 13. In this view, the ejector 17 thus transports the cut items completely out of the shaping gripper 13. However, if the gripper jaws are sufficiently wide open and the shaping gripper 13 is aligned accordingly, it may also be sufficient for the ejector 17 to convey the cut items 2 within the receptacle 16 in the direction of the distal end without protruding out of the shaping gripper 13.

FIG. 12 shows a schematic view of four shaping grippers 13, which are attached to a rotating device 34, for example. For the sake of clarity, one of the shaping grippers 13 is shown in a position relative to a receptacle 4 with a centering pin 8 and a food block 3 placed on it, as can be realized in a cutting and shaping device 1,

The rotating device 34 is designed as a gripper wheel. This means that it is rotatable about a second axis of rotation 37. It may be provided that rotation about the second axis of rotation 37 is provided in one direction—in this embodiment, the gripper wheel is rotatable in both directions about the second axis of rotation 37, By means of this rotational movement, when cut items have been separated from the food block with the knife 9 and they have been picked up in the shaping gripper 13, the now loaded shaping gripper 13 can be turned away immediately afterwards and an unloaded shaping gripper 13 can thus be automatically brought into a pick-up position close to the knife 9 and the food block 3. During this time, the knife 9 may already have entered the food block 3 and cut off the next cut item 2.

It is particularly advantageous if the loaded shaping gripper 13 can then discharge the shaped cut items 2 into a suitably positioned collecting container, for example a tray. In this way, the automated production of cut items 2 and the downstream shaping (and dispensing) of the cut items 2 can be accelerated, This acceleration can already be achieved by using two or more shaping grippers 13 on a holding or rotating device 34; an embodiment with four shaping grippers 13 on a rotating device 34 has proven to be particularly advantageous for the production of Tête de Moine rosettes,

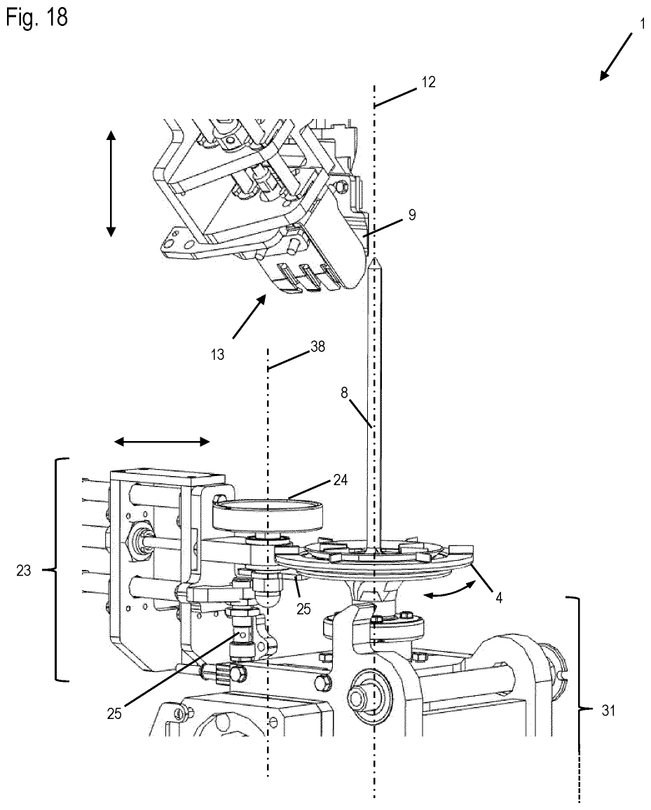

The automated rotation of the rotating device 34 is realized by means of a rotating device drive 35, which is controlled by the control unit 30. For reasons of clarity, the rotating device drive 35 is not shown here, but can be seen in FIG. 1 or FIG. 18, for example. The rotating device drive 35 can, for example, be a servomotor-controlled drive, a three-phase motor (for example with 230V or 400V) or a pneumatic rotary module.

To position a shaping gripper 13 of the rotating device 34, the rotating device can also be moved along the first axis of rotation 12, as previously discussed. For this purpose, the rotating device is integrated into the cutting and shaping device 1 in an axially movable manner.

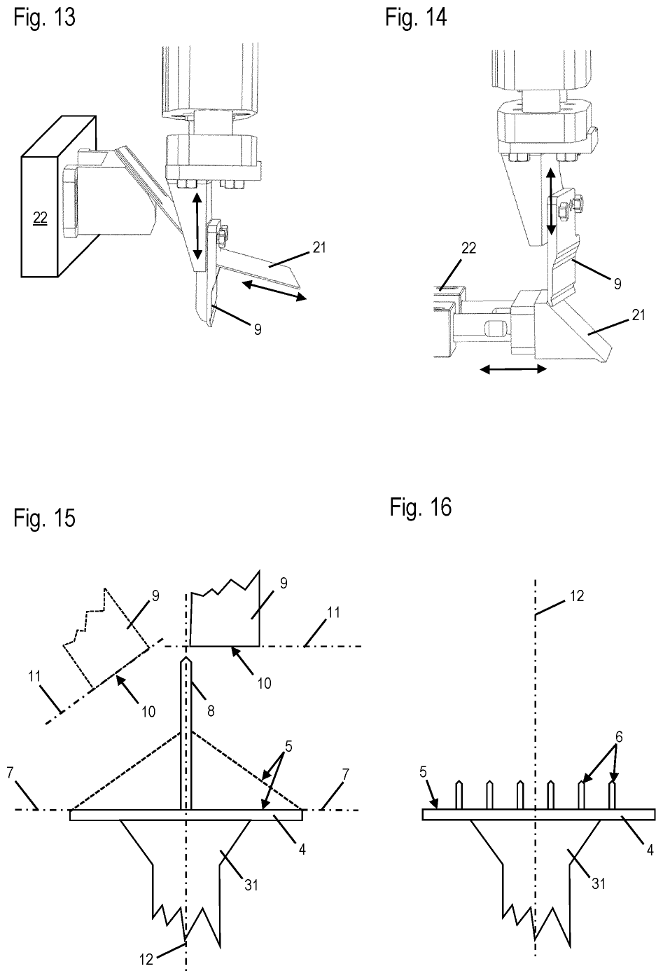

FIG. 13 shows a schematic view of a knife with an exemplary separating device 21. This is a highly simplified section. In the embodiment shown, it is an angled plate. For the sake of clarity, the angled plate is shown here as if it were penetrating the knife 9. In fact, the knife 9 and the separating device 21 must not come into contact with each other during operation of the cutting and shaping device 1; the chosen illustration is intended to make it clear that the separating device 21 crosses the path of the knife 9. The path of the knife 9 is understood here as the distance along which the knife 9 is moved up and down.

As explained above, the knife 9 is moved downwards, i.e. in the direction of the receptacle 4, until it pierces a food block 3 by a predefined depth. If the food block 3 is rotated, the cut items 2 are separated. Once the desired amount of cut items 2 has been separated, the knife 9 is retracted, i.e. moved upwards. The separating device 21 supports the transport of the cut items from the food block 3 into the shaping gripper 13 by moving the separating device 21, in this case the angled plate, in the direction of the shaping gripper 13, in FIG. 13 from left to right. The angled plate does not make contact with the knife 9, as the knife has been moved far enough upwards.

The separating device 21 is moved by means of its own movement device 22, which is controlled by the control unit 30. In this way, the movement of the separating device 21 is synchronized with the movement of the knife 9 and, advantageously, also with the rotational movement of the shaping gripper 13.

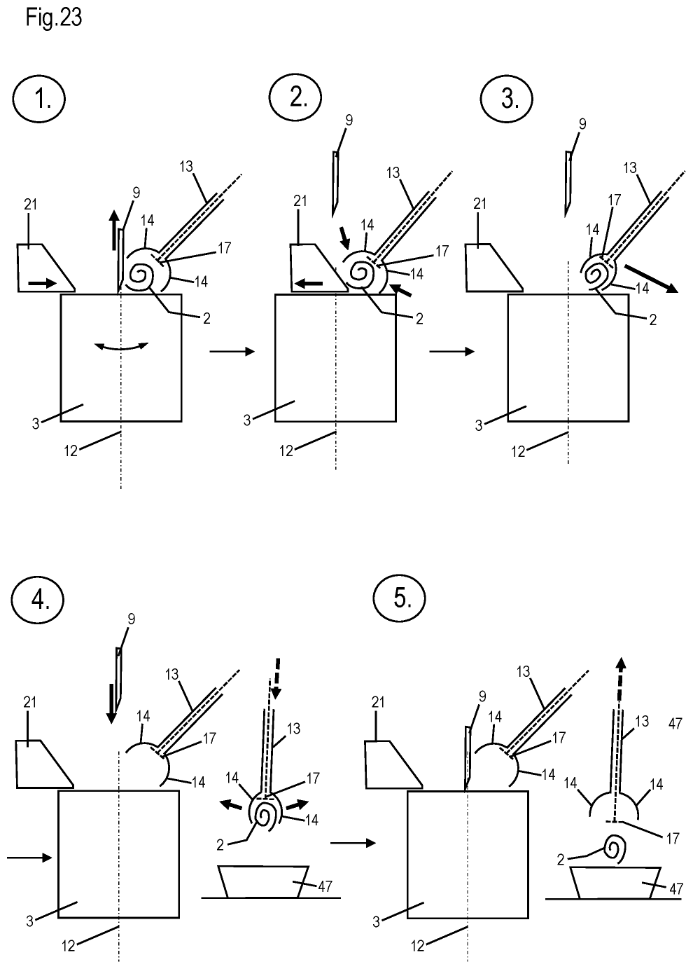

FIG. 14 shows a schematic view of a knife 9 with an alternative separating device 21. In this case, the separating device 21 is wedge-shaped, with the wedge tip aligned in the direction of knife 9 or shaping gripper 13 (not shown), By means of a separate movement device 22, the wedge-shaped separating device 21 can be moved back and forth along the direction of the arrow shown. Here, too, the knife 9 and the separating device 21 do not come into contact during operation—a more detailed description of an exemplary movement sequence can be found in FIG. 23.

The wedge shape makes it easy to move the cut items 2 into a correspondingly positioned shaping gripper 13.

FIG. 15 shows a highly schematized sectional drawing of a receptacle 4 with a centering pin 8, wherein the two possible, alternatively shaped receiving surfaces 5 and various possible positions of the knife 9 are shown. In one alternative shown, the receiving surface 5 is flat and extends in a first plane 7. This first plane 7 is in turn pierced vertically by the first axis of rotation 12. The knife 9 can, for example, be positioned relative to the receptacle 4 in such a way that its cutting edge 10 extends parallel to the first plane 7 (see knife 9 shown on the right). Alternatively, the knife 9 can be positioned in a different orientation (see knife 9 shown on the left). The drive 31 for the rotation of the receptacle 4 is indicated here.

If a receptacle 4 with a centering pin 8 is provided, the knife 9 must not contact the centering pin 8 or other holding elements 6 during operation of the cutting and shaping device 1. This can be achieved, for example, by appropriate positioning or by appropriate control of the movement using the control unit 30.

An alternative support surface 5 is shown with a dashed line. This support surface is conical in shape, with the tip of the cone lying in the first axis of rotation 12. Such a conical shape can be useful, for example, if the food block 3 already has a complementary shaped underside. The shape and size of the support surface 5 can therefore be adapted to the shape and size of the food block 3 to be processed.

FIG. 16 shows a highly schematized sectional drawing of a receptacle 4 with alternative holding elements 6. In this embodiment, the receptacle 4 has a plurality of pins that extend from the support surface 5 parallel to the axis of rotation 12. If the support surface 5 has a different shape, it is provided that the holding elements 6 are designed and oriented in such a way that they allow both a good hold for a food block 3 to be placed on top and good handling in connection with the placement of the food block 3.

In this figure, the knife 9, for example, is not shown for the sake of clarity. Only the drive 31 for rotating the receptacle 4 is indicated here.

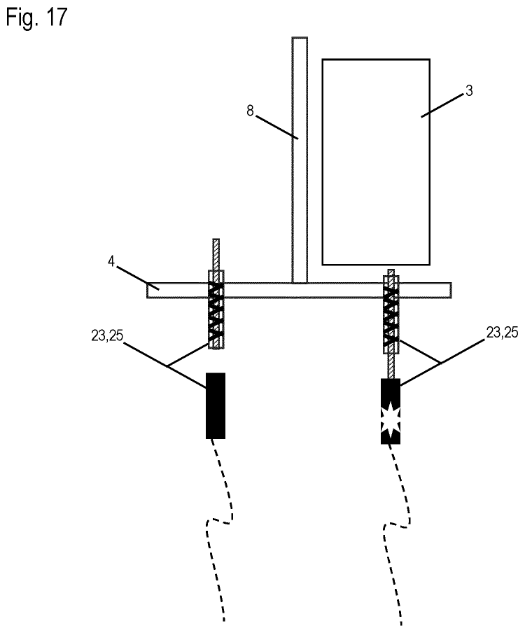

FIG. 17 shows a highly schematized overview of a monitoring device 23, which can be used to check whether a food block 3 is positioned on the receptacle 4 or not, The monitoring device 23 shown here is designed as a bolt with a spring return. The bolt is attached to the receptacle in such a way that it is pushed backwards into the housing when a food block 3 is placed on it and is thus detected by a sensor system 25. If the receptacle 4 is not occupied by a food block 3, the bolt protrudes upwards and cannot be detected by the sensor system 25. The sensor system 25 is in turn connected to a control unit 30 (not shown), which then controls the actions of the other elements of the cutting and shaping device 1.

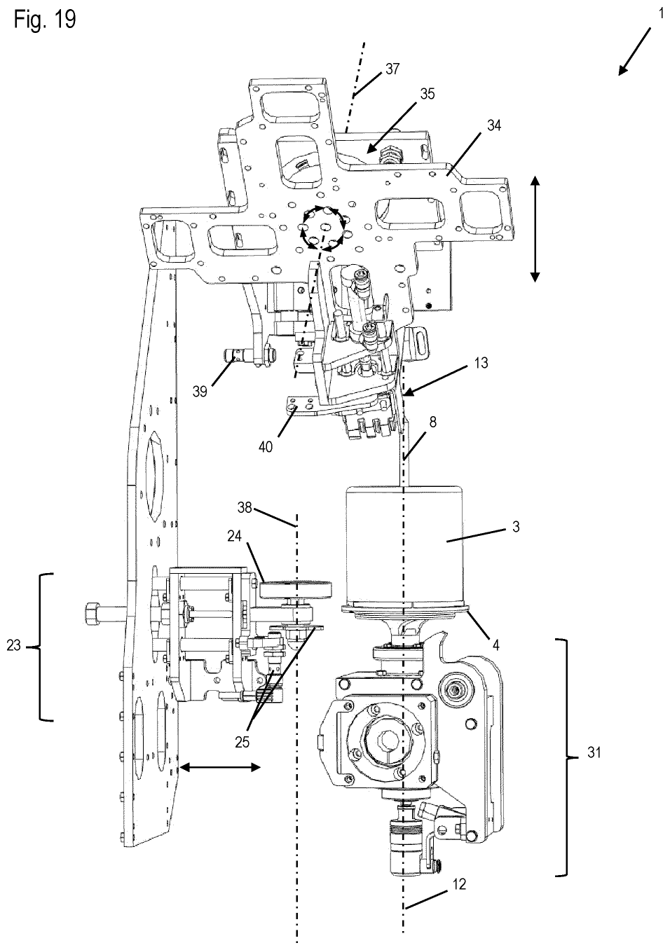

FIG. 18 shows a schematic section of a cutting and shaping device with an additional monitoring device 23 (for a complete overview, see FIG. 19). The shaping gripper 13 and the knife 9 are indicated here for the sake of clarity and are not shown fully installed. The receptacle 4 comprises a centering pin 8 and can be rotated about the first axis of rotation 12 by means of a rotation drive 31.

The monitoring device 23 is used to check whether a mounted food block 3 is rotating correctly with the receptacle 4. In this embodiment, the monitoring device 23 comprises a detection wheel 24, which can be moved perpendicular to the first axis of rotation 12. To monitor the rotation of the food block 3, the detection wheel 24 is moved so far in the direction of the first axis of rotation 12 that it rests lightly on the food block 3. As a result, the detection wheel 24 accordingly also rotates in the opposite direction. The corresponding axis of rotation 38 of the detection wheel 24 is shown in FIG. 18. It may be provided that the pressure with which the detection wheel 24 comes to rest on the food block 3 can be controlled, for example by means of the control unit 30.

A sensor system 25 is then used to monitor the rotation of the detection wheel 24 in order to draw conclusions about the rotation of the food block 3. The term sensor system 25 refers here not only to a signal detector, but to a unit or combination of a signal detector and a signal trigger. The signal trigger comprises or causes a signal that can be detected by the signal detector. The sensor system 25 or parts thereof are also functionally connected to the control unit 30. The control unit 30 is designed to receive and process a signal forwarded by the sensor system, for example by triggering an alarm if, despite rotating receptacle 4 and food block 3 in place, the detection wheel 24 does not rotate (correctly).

In the embodiment shown in FIG. 18, the check is carried out using a combination of an inductive proximity sensor 25 and a half disk 25 made of metal, for example stainless steel. The half disk functions here as a signal trigger, the inductive proximity sensor as a signal detector. The half disk and the detection wheel 24 are mounted on the same axis so that the half disk rotates with the detection wheel 24 when it is rotated by the food block 3. When the food block 3 rotates properly, the detection wheel 24 also rotates and with it the half disk at a corresponding speed. The half disk is positioned opposite the sensor in such a way that the sensor detects the presence of the metal half side at regular intervals. No signal is detected and forwarded to the control unit 30 if the half disk is not in front of the sensor due to the rotation, The inductive proximity sensor detects the presence of the half disk at regular intervals and forwards a corresponding signal to the control unit. As long as the time interval between the signals remains unchanged or is within a predetermined range, it can be concluded that the food block 3 is also rotating correctly. If the detected signal deviates, this may indicate that the food block 3 is not rotating properly, for example because it is broken or has become detached from the receptacle 4. In this case, it may be provided that the control unit can be used to stop the rotation of the receptacle 4, for example, in order to replace the food block 3.

FIG. 19 shows a schematic side view of a cutting and shaping device 1 according to FIG. 18 with an additional rotary wheel for four shaping grippers 13. A retaining plate is indicated on the left-hand side of this figure, to which, for example, the monitoring device, the knife 9 and the shaping gripper 13 including the detection wheel 34 can be attached in an axially guided manner. The fastenings and connections are not shown for reasons of clarity.

In this preferred embodiment, the cutting and shaping device 1 shown comprises a rotating wheel in addition to the rotatable receptacle 4, which is designed for the attachment of four shaping grippers 13. However, only the position of one shaping gripper 13 is shown here, wherein the complete attachment has also been omitted here.

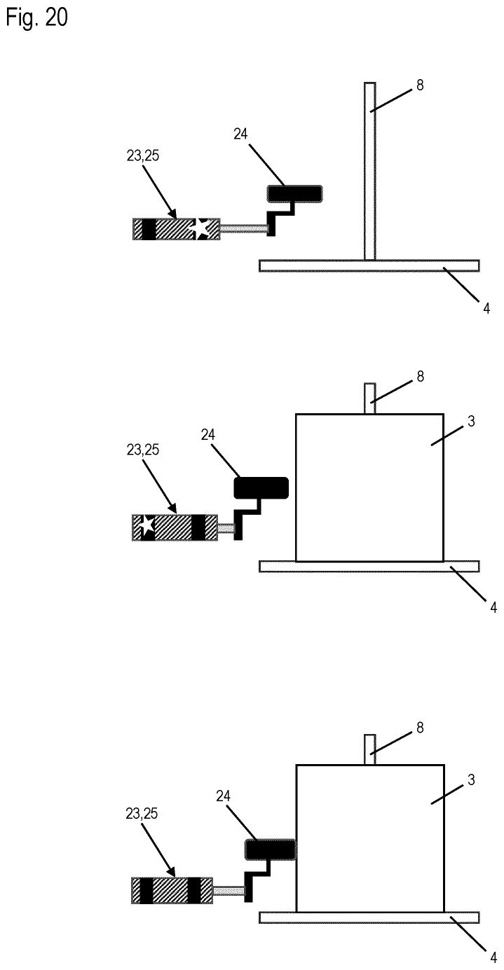

FIG. 20 shows a schematic diagram of the function of a detection wheel 34 in an exemplary embodiment. The monitoring device 23 here comprises a two-part sensor system 25 coupled to the detection wheel 24. In particular, it comprises two reed sensors connected in series, which are connected to a cylinder coupled to the detection wheel 24. If there is no food block 3 on the receptacle 4 (whether intentionally or unintentionally), the cylinder and thus the detection wheel 24 is fully extended. This cylinder position can be detected by the first sensor facing the detection wheel 24 (upper situation).

In a waiting position (FIG. 20 center), the cylinder with the detection wheel 24 is fully retracted so that the second, rear sensor triggers a corresponding signal and reports it back to the control unit 30. A signal from this second sensor indicates that the cutting and shaping device 1 is ready.

In a detection position (FIG. 20 below), the cylinder and the detection wheel 24 are partially extended. In this position, the detection wheel 24 acts on an existing and rotating food block 3. In this position, however, no signal is triggered, neither at the first nor at the second sensor. This non-existent signal can be interpreted by the control unit 30 as indicating that a food block is correctly positioned and rotated.

The signals of the corresponding cylinder positions can be processed by the control unit 30 (not shown) according to the specifications for the further operation of the cutting and shaping device 1.

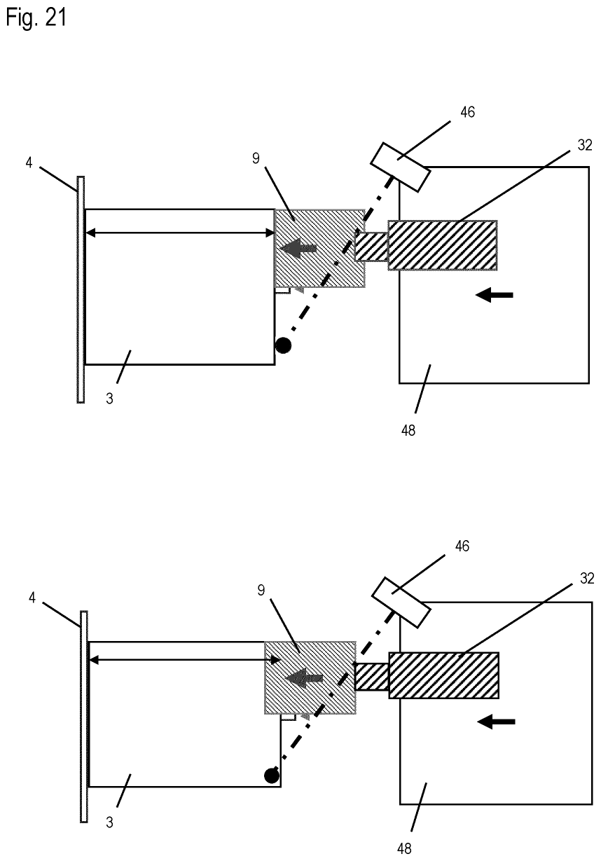

FIG. 21 schematically illustrates a further, alternative monitoring device 23 and its mode of operation. In this embodiment, the monitoring device 23 comprises a laser 46, which is connected in a fixed position to the knife and/or its drive 32. In this figure, the laser 46 and the knife drive 32 are attached to a common holder 48. Accordingly, when the knife 9 is moved in the direction of the receptacle 4 by means of the knife drive 32 to cut off the cut items 2, the laser 46 is also moved in the direction of the receptacle.

The laser 46 is aligned in such a way that it is focused on a defined laser point. In normal operation, this laser spot is located just above the surface of the attached food block 3, i.e. slightly above the cutting edge 10 of the knife 9. If cut items 2 are continuously cut off the food block 3 during normal operation, the laser spot is still not located on the food block 3, as the height of the food block 3 (see double arrow) is continuously reduced (top view). However, if cut items 2 are not cut off, the knife 9 continues to move in the direction of the receptacle 4, but the height of the food block 3 (see double arrow, lower view) does not change, so that the laser dot is located in the food block 3. The laser therefore looks at the food block 3 and the detected signal can be recognized as an error by the control unit 30.

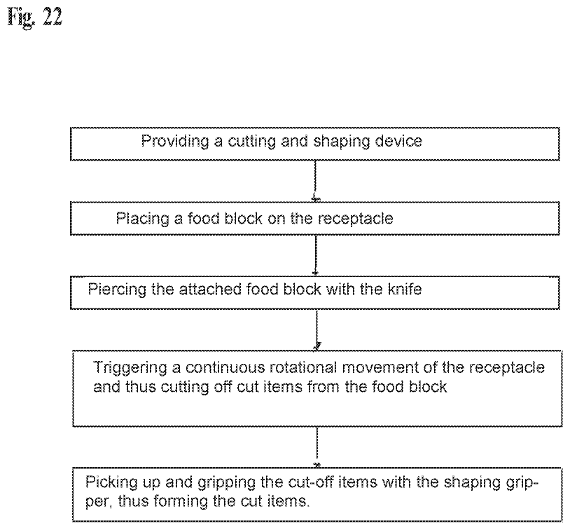

FIG. 22 shows a schematic overview of possible method steps in the production of shaped cut items 2 by means of a cutting and shaping device 1 according to the present invention.

FIG. 23 shows a highly schematized example of a sequence of method steps for gripping and forming cut items 2. The respective directions of movement are indicated by bold arrows. It is provided that the movements shown are controlled by a control unit 30:
1. Due to a rotational movement of the food block 3, the cut items 2 are first scraped off by the attached knife 9. In an open state of the gripper jaws 14, the shaping gripper 13 is positioned opposite the cutting edge 10 of the knife 9 in such a way that the cut-off items 2 come to rest in the receptacle 16. For gripping and shaping, the knife 9 is moved upwards along the first axis of rotation 12 while the separating device 21, in this case wedge-shaped, is also moved in the direction of the shaping gripper 13. The movement of the wedge-shaped separating device 21 pushes the cut items 2 completely into the receptacle 16 of the shaping gripper.
2. The cut items 2 are completely in the shaping gripper 13. The separating device 21 is moved back into the passive position. In addition, the gripper jaws 14 are moved towards each other and thus brought into a closed state.
3. By closing the gripper jaws 14, the cut items 2 are brought into the desired shape. This also ensures that the cut items 2 do not fall out during transportation when the shaping gripper 13 is moved away from the food block 3. The extent to which the gripper jaws 14 are closed can depend, for example, on the desired shape and consistency of the cut items 2.
4. The shaping gripper 13 is moved away from the food block 3 with the cut items 2 and positioned above a container 47. To eject the cut items 2 into the container 47, the gripper jaws 14 are opened and the ejector 17 is moved out of the shaping gripper 13. The cut items 2 can thus fall into the container. Meanwhile, the knife 9 can be repositioned on the food block 3 and a new, empty shaping gripper 13 is aligned opposite the positioned knife 9.
5. The cut items 2 fall into the container 47 provided. The ejector 17 can be retracted back into the shaping gripper 13. In addition, the knife 9 and the new shaping gripper 13 are positioned in such a way that the food block 3 is rotated again and the next cut item 2 is separated. In particular, it may be provided that the number of shaping grippers 13 used and their movements as well as the movement of the knife 9 and the separating device and the rotation of the food block 3 are coordinated in such a way that a virtually continuous separation of cut items 2 from the food block 3 can take place.

### LIST OF REFERENCE SIGNS

1 Cutting and shaping device
2 Cut items monitoring device
3 Food block
4 Receptacle
5 Support surface
6 Holding element
7 First plane
8 Centering pin
9 Knife
10 Cutting edge
11 Second plane
12 First axis of rotation
13 Shaping gripper
14 Gripper jaw
15 Inner side of the gripper jaw
16 Receptacle for planed material
17 Ejector
18 Support surface of the ejector
19 Gripper holder
20 Limiting element
21 Separating device
22 Movement device of the separating device
23 Monitoring device
24 Detection wheel
25 Sensor system of the monitoring device
30 Control unit
31 Receptacle drive
31′ Gear of the receptacle drive
31″ Motor of the receptacle drive
32 Knife drive
33 Shaping gripper drive
34 Rotating device of the shaping gripper
35 Rotating device drive
36 Separating device drive
37 Axis of rotation of the gripper wheel
38 Axis of rotation of the detection wheel
39 Sensor
40 Jaw receptacle
41 Adapter plate
42 Fixing plate
43 Distal end of the shaping gripper
44 Movement unit of the gripper jaws
45 Guide rod

1. A cutting and shaping device (1) for producing formed cut items (2) from a food block (3), the cutting and shaping device (1) comprising:
a receptacle (4) having a support surface (5) on which a food block (3) can be positioned,
a knife (9) having a cutting edge (10) for cutting off cut items (2) when the food block (3) is positioned on the support surface (5) of the receptacle (4),
wherein the knife (9) or the receptacle (4) rotates about a first axis of rotation (12), or wherein the knife (9) and the receptacle (4) rotate about the first axis of rotation (12), and
wherein the knife (9) and the receptacle (4) are movable relative to one another along the first axis of rotation (12),
a shaping gripper (13), which can be aligned with a distal end thereof towards the cutting edge (10) of the knife and which automatically grips and shapes cut items (2), and
a control unit (30) which controls the shaping gripper, the knife and the receptacle and controls the positions of the shaping gripper, the receptacle and the knife relative to one another.

2. The cutting and shaping device (1) according to claim 1, wherein the shaping gripper (13) comprises at least two gripper jaws (14), each with an inner side (15), which are movable relative to one another, wherein the gripper jaws (14) jointly form with their inner sides (15) a shaping receptacle (16) for cut items (2) that are cut off from a food block (3).

3. The cutting and shaping device (1) according to claim 2, wherein the shaping gripper (13) is an angular gripper or a parallel gripper.

4. The cutting and shaping device (1) according to claim 2, wherein the gripper jaws (14) are arranged relative to one another in such a way that they form a conical receptacle (16) at the distal end of the shaping gripper (13).

5. The cutting and shaping device (1) according to claim 2, wherein the shaping gripper (13) comprises an ejector (17) with a support surface (18) for cut items (2), wherein the ejector (17) is movable back and forth in the receptacle (16) and in a direction of the distal end of the shaping gripper (13).

6. The cutting and shaping device (1) according to claim 2, wherein at least one of the gripper jaws (14) at the distal end of the shaping gripper (13) is finger-shaped with a recess between each finger.

7. The cutting and shaping device (1) according to claim 1, wherein the receptacle (4) rotates at a rotational speed about the first axis of rotation (12), wherein the cutting and shaping device (1) comprises a receptacle drive (31) for rotating the receptacle about the first axis of rotation (12), which drive is controlled by the control unit (30).

8. The cutting and shaping device (1) according to claim 7, wherein the knife (9) and the shaping gripper (13) are movable parallel to the first axis of rotation (12), wherein the control unit (30) controls movement of the knife (9) and the shaping gripper (13) parallel to the first axis of rotation (12).

9. The cutting and shaping device (1) according to claim 7, comprising: a knife drive (32), with which the knife (9) is moved parallel to the first axis of rotation (12), and a shaping gripper drive (33), with which the shaping gripper (13) is moved parallel to the first axis of rotation (12).

10. The cutting and shaping device (1) according to claim 1, wherein the shaping gripper (13) is fastened to a rotating device (34) with which the shaping gripper (13) can be moved relative to the first axis of rotation (12), wherein the rotating device (34) is operatively connected to a rotating device drive (35).

11. The cutting and shaping device (1) according to claim 1, wherein the cutting edge (10) of the knife (9) extends perpendicular to the first axis of rotation (12) and is arranged adjacent to this first axis of rotation (12).

12. The cutting and shaping device (1) according to claim 1, wherein the support surface (5) of the receptacle (4) is plate-shaped and extends perpendicular to the first axis of rotation (12).

13. The cutting and shaping device (1) according to claim 1, wherein the receptacle (4) comprises one or more holding elements (6) which are arranged at least on the support surface (5) for holding a food block (3) to be placed on the receptacle (4).

14. The cutting and shaping device (1) according to claim 12, comprising a holding element (6) selected from a group comprising:
a web that extends from the receptacle (4) in a direction of the slicing knife (9),
a mandrel or clamping nail that extends from the receptacle (4) in the direction of the slicing knife (9),
a pair of claws or grippers, which are arranged to a side of the support surface (5) and clamp the food block in order to hold it in place,
a clamping ring, and
a vacuum device which suctions in a food block (3) placed on the receptacle (4).

15. The cutting and shaping device (1) according to claim 1, comprising a separating device (21) for guiding cut-off items (2) into the shaping gripper, wherein the separating device (21) is movable back and forth relative to the first axis of rotation (12), wherein movement of the separating device (21) is controlled by the control unit (30) as a function of the position of the knife (9)

16. The cutting and shaping device (1) according to claim 15, wherein the separating device (21) is sheet-shaped or wedge-shaped and moves perpendicular to the first axis of rotation (12), or in that the separating device (21) is an angled sheet which tilts with respect to the first axis of rotation (12), wherein the cutting and shaping device comprises a separating device drive (36) with which movement of the separating device (21) is carried out under the control of the control unit (30).

17. The cutting and shaping device (1) according to claim 1, wherein the receptacle (4) comprises a centering pin (8) which extends essentially perpendicularly from the support surface (5) of the receptacle (4) in [[the]] a direction of the slicing knife (9) along the first axis of rotation (12),

18. The cutting and shaping device (1) according to claim 1, comprising a monitoring device (23) which detects a presence of a food block (3) positioned on the receptacle (4), wherein the monitoring device (23) is controlled by the control unit.

19. The cutting and shaping device according to claim 18, wherein the monitoring device (23) comprises a detection wheel (24) which rotates about a second axis of rotation (25), wherein the second axis of rotation (25) extends parallel to the first axis of rotation (12), and wherein the detection wheel moves with the second axis of rotation (25) parallel opposite and perpendicular to the first axis of rotation (12).

20. The cutting and shaping device (1) according to claim 19, wherein the monitoring device (23) comprises a sensor system (25) which detects a rotation of the detection wheel (24).

21. The cutting and shaping device (1) according to claim 18, wherein the monitoring device (23) comprises a laser which is connected in a fixed position to the knife or the knife drive (32) and which is aligned with a laser point which is located above the upper side of the food block when the food block is in place and the knife has cut it off correctly.

22. The cutting and shaping device (1) according to claim 1, comprising a holding element (6) on the receptacle (4), which is a vacuum device for applying suction to a food block (3) placed on the receptacle (4), wherein the vacuum device comprises at least one vacuum sensor for detecting a vacuum at the receptacle (4).

23. The cutting and shaping device (1) according to claim 1, configured for automated production of shaped Tête de Moine rosettes.

24. A shaping gripper (13) for automated shaping of Tête de Moine rosettes in a cutting and shaping device (1) according to claim 1, wherein the shaping gripper (13) comprises at least two gripper jaws (14) which can be moved against one another and each have an inner side (15), wherein the gripper jaws (14) jointly form a Tête de Moine rosette-shaping receptacle (16) with their inner sides (15).

25. The shaping gripper (13) according to claim 24, wherein the shaping gripper (13) is fastened to a rotating device (34) with which the shaping gripper can be moved relative to the first axis of rotation (12) of the cutting and shaping device (1), wherein the rotating device (34) is a rotary wheel which comprises two or more holding places for fastening further shaping grippers (13), and wherein the rotary wheel is operatively connected to a rotating device drive (35).

26. A method for producing shaped cut items (2) of a food block (3), comprising;
providing a cutting and shaping device (1) according to claim 1,
placing a food block (3) on the support surface (5) of the receptacle (4),
moving the knife (9) and/or receptacle (4) towards each other under the control of the control unit (30) until the knife (9) pierces the top of the attached food block (3),
triggering a rotational movement of the slicing knife (9) and/or the receptacle (4) about the first axis of rotation (12) and continuous movement of the knife (9) and/or the receptacle (4) against each other, thereby cutting off a cut item (2) from the top of the attached food block (3), and
positioning the shaping gripper (13) relative to the surface of the attached food block (3), as well as picking up and gripping the cut items (2) in the shaping gripper (13), wherein the cut items (2) are formed.

27. The method for producing shaped cut items (2) according to claim 26, wherein the receptacle (4) rotates about the first axis of rotation (12) and, for piercing, the knife (9) is moved along the first axis of rotation (12) in [[the]] a direction of the receptacle (4) until the cutting edge (10) pierces the food block (3).

28. The method for producing shaped cut items (2) according to claim 27, wherein the knife (9) is moved away from the food block (3) to interrupt the cutting of cut items (2).

29. The method for producing shaped cut items (2) according to claim 26, wherein the shaping gripper (13) comprises two gripper jaws (14) which are movable relative to each other and which are positioned opposite the knife (9) during the cutting off of cot items (2), wherein the gripper jaws (14) each comprise an inner side (15), with which they jointly form a shaping receptacle (16) for cut items (2) cut off from a food block (3), and wherein the gripper jaws (14) are moved away from one another to pick up cut items (2) cut off by the knife (9) and are moved towards one another to shape the picked-up cut items (2).

30. The method for producing shaped cut items (2) according to claim 26, wherein the shaping gripper (13) has an ejector (17) with a support surface (18), wherein cut items (2) received in the shaping gripper (13) lie on the support surface (18) and/or are discharged from the shaping gripper (13) by the ejector (17).

31. The method for producing shaped cut items (2) according to claim 26, wherein the picked-up and shaped cut items (2) are transported away from the food block (3) by the shaping gripper (13).

32. The method for producing shaped cut items (2) according to claim 26, wherein the cutting and shaping device (1) comprises a separating device (21) for guiding cut items (2) from the knife (9) into the shaping gripper (13), wherein, in order to pick up the cut items (2) into the shaping gripper, the knife (9) is retracted and the separating device (21) is simultaneously moved in a direction of the shaping gripper (13), so that the cut items (2) cut off by the knife (9) are guided into the shaping gripper (13) under the action of the separating device (21).

33. The method for producing shaped cut items (2) according to claim 26, wherein the cutting and shaping device (1) comprises a monitoring device (23) with a detection wheel (24) and a sensor system (25), wherein the rotation of the attached food block (3) is monitored by moving the detection wheel (24) in a direction of the food block (3) until it acts on the food block (3), and wherein the resulting rotation of the detection wheel (24) is detected by the sensor system (25).

34. The method for producing shaped cut items (2) according to claim 26, wherein the food block (3) is a Tête de Moine cheese block and Tête de Moine rosettes are scraped off and shaped with the cutting and shaping device (1).
